(19) United States
(12) Patent Application Publication
(10) Pub. No.: US 2026/0318871 A1
(43) Pub. Date: Oct. 15, 2026

(54) DETECTOR, DETECTING DEVICE, AND METHOD OF DETECTING CHARGED PARTICLES

(71) Applicant: SHARP KABUSHIKI KAISHA, Sakai City (JP)

(72) Inventors: RESHAN MADUKA ABEYSINGHE, Sakai City (JP); YUUKI OOTSUKA, Sakai City (JP); Manabu DAIO, Sakai City (JP); Tsukasa TANIGUCHI, Sakai City (JP); Shuhei SOTA, Sakai City (JP)

(21) Appl. No.: 19/641,904

(22) Filed: Apr. 8, 2026

(30) Foreign Application Priority Data
Apr. 15, 2025 (JP) 2025-066773

(51) Int. Cl. G01N 27/624

(52) U.S. Cl. CPC G01N 27/624

(57) ABSTRACT

A detector includes a first electrode, a second electrode opposed to and spaced from the first electrode to form a flow space of charged particles between the first electrode and the second electrode such that the charged particles are transferred in the flow space in a first direction, a third electrode disposed on a downstream side of the first electrode or the second electrode with respect to the first direction and collecting the charged particles, a fourth electrode disposed on an upstream side of the first electrode with respect to the first direction and applied with a calibration voltage, and a fifth electrode that is disposed on the upstream side of the second electrode with respect to the first direction and opposed to and spaced from the fourth electrode. The charged particles adhere to the fifth electrode with the fourth electrode being applied with the calibration voltage.

### CROSS REFERENCE TO RELATED APPLICATION

This application claims priority from Japanese Patent Application No. 2025-066773 filed on Apr. 15, 2025. The entire contents of the priority application are incorporated herein by reference.

### TECHNICAL FIELD

The technology described herein is related to a detector, a detecting device, and a method of detecting charged particles.

### BACKGROUND

There has been known a detecting device that separates and detects ions based on ion mobility. One example of such a detecting device is a drift type ion mobility spectrometer. Such a drift type ion mobility spectrometer includes an ion source and a mobility analyzer. The ion source includes a first ionization region that is fluidly coupled to a sample source, a second ionization region that is spatially separated from the first ionization region and fluidly coupled to a calibrant reservoir, and an ion transfer system for controlling the transfer of sample ions from the first ionization region into other ionization region, and/or the transfer of sample ions from at least one ionization region into a third region. The third region is fluidly coupled to the first and second ionization regions and located closer to the mobility analyzer than the first and second ionization regions.

In such a drift type ion mobility spectrometer, by selectively supplying electricity to the grids that separate the first ionization region, the second ionization region, and the third region, sample ions and calibrant ions from the sample source are selectively transferred into the third region and the calibrant spectrum and the sample spectrum can be acquired by the mobility analyzer. The acquired calibrant spectrum is used for calibrating the mobility axis of a sample spectrum. However, in the drift type ion mobility spectrometer, the amount of ions supplied from the ion source may be varied due to the individual differences of the ion sources and the amount of supplied ions may be varied due to individual differences of the sample to be analyzed. Due to such variations, the detection current detected by the mobility analyzer may be varied and the variation in the detected current cannot be not calibrated.

### SUMMARY

The technology described herein was made in view of the above circumstances. An object is to calibrate a detection current.
(1) A detector device according to the technology described herein includes a first electrode, a second electrode opposed to and spaced from the first electrode to form a flow space of charged particles between the first electrode and the second electrode such that the charged particles are transferred in the flow space in a first direction, a third electrode disposed on a downstream side of the first electrode or the second electrode with respect to the first direction and collecting the charged particles, a fourth electrode disposed on an upstream side of the first electrode with respect to the first direction and applied with a calibration voltage, and a fifth electrode that is disposed on the upstream side of the second electrode with respect to the first direction and opposed to and spaced from the fourth electrode. The charged particles adhere to the fifth electrode with the fourth electrode being applied with the calibration voltage.
(2) The detector may further include, in addition to (1), a first substrate having a first surface and a second substrate having a second surface that is opposed to and spaced from the first surface. The first electrode may include first electrodes that are arranged at intervals in a second direction crossing the first direction and being along the first surface and the second surface. The second electrode may include second electrodes that are arranged at intervals in the second direction. The third electrode may include third electrodes that are arranged at intervals in the second direction. The fourth electrode may include fourth electrodes that are arranged at intervals in the second direction. The fifth electrode may include fifth electrodes that are arranged at intervals in the second direction. The first electrodes and the fourth electrodes may be disposed on the first surface. The second electrodes and the fifth electrodes may be disposed on the second surface. The third electrodes may be disposed on the first surface or the second surface.
(3) A detecting device according to the technology described herein includes the detector according to (1) or (2) and a calibration voltage supply section configured to supply the calibration voltage to the fourth electrode.
(4) In the detecting device, in addition to (3), the calibration voltage supply section may be configured to supply the fourth electrode with a signal having a constant amplitude and a modulated pulse width as the calibration voltage.
(5) In the detecting device, in addition to (3), the calibration voltage supply section may be configured to supply the fourth electrode with a signal having a constant pulse width and a modulated amplitude as the calibration voltage.
(6) In the detecting device, in addition to (3), the fourth electrode may include separated electrodes and the calibration voltage supply section may be configured to selectively supply the separated electrodes with the calibration voltage.
(7) In the detecting device, in addition to (6), the detector may include a first substrate that has a first surface and on which at least the first electrode and the fourth electrode are disposed, and a second substrate that has a second surface opposed to and spaced from the first surface and on which at least the second electrode and the fifth electrode are disposed. The separated electrodes may be arranged at intervals in a second direction that crosses the first direction and is along the first surface and the second surface. The calibration voltage supply section may be configured to selectively supply the separated electrodes with a DC voltage as the calibration voltage.
(8) The detecting device may further include, in addition to any one of (3) to (7), a charged particle supply section configured to supply the detector with the charged particles. The detector may further include a first substrate that has a first surface and on which at least the first electrode and the fourth electrode are disposed, and a second substrate that has a second surface opposed to and spaced from the first surface and on which at least the second electrode and the fifth electrode are disposed. The first electrode may include first electrodes that are arranged at intervals in a second direction crossing the first direction and being along the first surface and the second surface. The second electrode may include second electrodes that are arranged at intervals in the second direction. The third electrode may include third electrodes that are arranged at intervals in the second direction. The fourth electrode may include fourth electrodes that are arranged at intervals in the second direction. The fifth electrode may include fifth electrodes that are arranged at intervals in the second direction. The charged particle supply section may include charged particle supply sections that are arranged in the second direction. The number of the charged particle supply sections may be same as the number of each of the first electrodes, the second electrodes, the third electrodes, the fourth electrodes, and the fifth electrodes.
(9) In the detecting device, in addition to (8), the first electrodes and the fourth electrodes may be disposed on the first surface. The second electrodes and the fifth electrodes may be disposed on the second surface. The third electrodes may be disposed on the first surface or the second surface.
(10) In the detecting device, in addition to any one of (3) to (9), the detector may include a first substrate that has a first surface and on which at least the first electrode and the fourth electrode are disposed, and a second substrate that has a second surface opposed to and spaced from the first surface and on which at least the second electrode and the fifth electrode are disposed. The detector may include detectors that are arranged at intervals in a second direction crossing the first direction and being along the first surface and the second surface.
(11) A method of detecting charged particles according to the technology described herein is a method with using a detector that includes a first electrode, a second electrode opposed to and spaced from the first electrode to form a flow space of charged particles between the first electrode and the second electrode in which the charged particles are transferred in a first direction, a third electrode disposed on a downstream side of the first electrode or the second electrode with respect to the first direction and collecting the charged particles, a fourth electrode disposed on an upstream side of the first electrode with respect to the first direction and applied with calibration voltage, and a fifth electrode that is disposed on the upstream side of the second electrode with respect to the first direction and opposed to and spaced from the fourth electrode and to which the charged particles adhere with the fourth electrode being applied with the calibration voltage. The method includes supplying the charged particles to the flow space with no potential difference being created between the first electrode and the second electrode and detecting a first detection voltage by collecting the charged particles with the third electrode, obtaining a differential voltage by acquiring difference between the first detection voltage and a reference voltage and determining the calibration voltage based on the differential voltage, and supplying the charged particles to the flow space with creating a potential difference between the first electrode and the second electrode and applying the calibration voltage to the fourth electrode, and detecting a second detection voltage by collecting the charged particles with the third electrode.

According to the technology described herein, a detected current can be calibrated.

### BRIEF DESCRIPTION OF THE DRAWINGS

FIG. 1 is a general view illustrating a configuration of a mobility analyzer including a detection cell according to a first embodiment.

FIG. 2 is a block diagram of a control section included in the mobility analyzer according to the first embodiment.

FIG. 3 is a map graph illustrating a FAIMS spectrum obtained by the mobility analyzer according to the first embodiment.

FIG. 4 is a plan view of a first substrate of the detection cell according to the first embodiment.

FIG. 5 is a plan view of a second substrate of the detection cell according to the first embodiment.

FIG. 6 is a plan view of the mobility analyzer according to the first embodiment.

FIG. 7 is a graph representing a first detection voltage detected by a detection electrode of a first electrode group according to the first embodiment.

FIG. 8 is a graph representing a first detection voltage detected by a detection electrode of a second electrode group according to the first embodiment.

FIG. 9 is a graph representing a first detection voltage detected by a detection electrode of a third electrode group according to the first embodiment.

FIG. 10 is a graph representing a waveform of a calibration voltage (a PWM signal) to be applied to an upper electrode of the first electrode group according to the first embodiment.

FIG. 11 is a graph representing a waveform of a calibration voltage (a PWM signal) to be applied to an upper electrode of the first electrode group according to the first embodiment.

FIG. 12 is a graph representing a waveform of a calibration voltage (a PWM signal) to be applied to an upper electrode of the first electrode group according to the first embodiment.

FIG. 13 is a graph representing a voltage detected by the detection electrode included in each electrode group according to the first embodiment.

FIG. 14 is a block diagram of a control section included in a mobility analyzer according to a second embodiment.

FIG. 15 is a graph representing a waveform of a calibration voltage to be applied to an upper electrode of a first electrode group according to the second embodiment.

FIG. 16 is a graph representing a waveform of a calibration voltage to be applied to an upper electrode of a second electrode group according to the second embodiment.

FIG. 17 is a graph representing a waveform of a calibration voltage to be applied to an upper electrode of a third electrode group according to the second embodiment.

FIG. 18 is a plan view of a first substrate included in a detection cell according to a third embodiment.

FIG. 19 is a block diagram of a control section included in a mobility analyzer according to the third embodiment.

FIG. 20 is a graph representing a waveform of a calibration voltage to be applied to an upper electrode of each electrode group according to the third embodiment.

FIG. 21 is a cross-sectional view of the mobility analyzer according to the third embodiment taken along xxi-xxi line in FIG. 18.

FIG. 22 is a cross-sectional view of the mobility analyzer according to the third embodiment taken along xxii-xxii line in FIG. 18.

FIG. 23 is a plan view of a mobility analyzer according to a fourth embodiment.

FIG. 24 is a plan view of a mobility analyzer according to a fifth embodiment.

FIG. 25 is a plan view of a mobility analyzer according to a sixth embodiment.

FIG. 26 is a general view illustrating a configuration of a mobility analyzer according to a seventh embodiment.

FIG. 27 is a general view illustrating a configuration of a mobility analyzer according to an eighth embodiment.

FIG. 28 is a general view illustrating a configuration of a mobility analyzer according to a ninth embodiment.

FIG. 29 is a general view illustrating a configuration of a mobility analyzer according to a tenth embodiment.

FIG. 30 is a general view illustrating a configuration of a mobility analyzer according to an eleventh embodiment.

FIG. 31 is a general view illustrating a configuration of a mobility analyzer according to a twelfth embodiment.

### DETAILED DESCRIPTION

### First embodiment

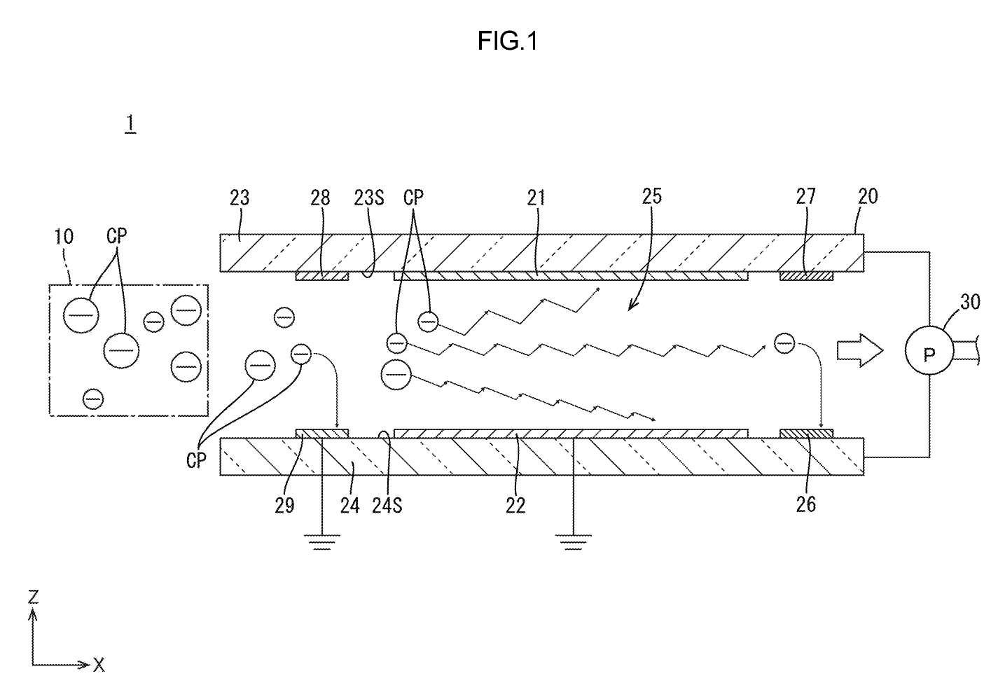

A first embodiment will be described with reference to FIGS. 1 to 13. A mobility analyzer 1 (simply referred to as an analyzer) using a field asymmetric ion mobility spectrometry (FAIMS) system will be described. X-axes, Y-axes, and Z-axes are in some of the drawings and the axes in each drawing indicate directions that correspond to directions indicated by the respective axes in other drawings.

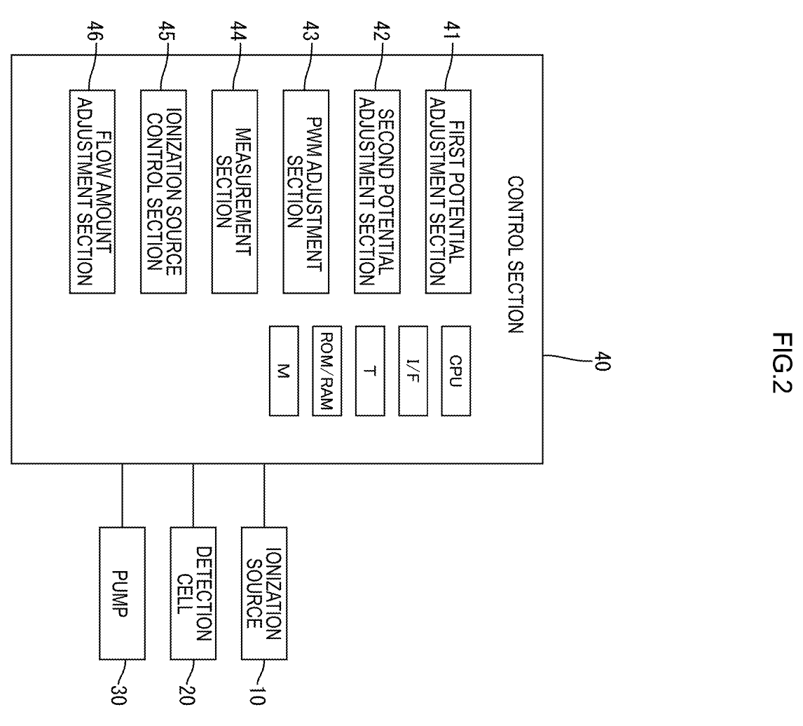

As illustrated in FIGS. 1 and 2, the analyzer 1 (a detecting device) includes an ionization source 10 (a charged particle supply section), a detection cell 20 (a detector), a pump 30 (one example of air supply device), and a control section 40. Each component will be described below.

The ionization source 10 is a device of ionizing atoms and molecules of a compound which is a sample to be analyzed. The compound that is ionized by the ionization source 10 becomes charged particles CP (sample ions) that can be detected by the detection cell 20. The charged particles CP are objects to be detected by the detection cell 20. The ionization method of the ionization source 10 is not particularly limited and various kinds of known ionization sources can be used. Examples of the ionization method include electron impact (EI) ionization, chemical ionization (atmospheric pressure chemical ionization (APCI)), gas-discharge ionization, photoionization, deposition ionization, electrospray ionization (ESI), thermal ionization, and ambient ionization. A combination of the example methods may be used as the ionization method. The ionization source may be appropriately selected such that components that need to be detected can be ionized. This embodiment includes a needle electrode as the ionization source 10. Corona discharge occurs by the needle electrode under an atmospheric pressure to create reactive ions. The reactive ions react with sample atoms and sample molecules and the charged particles CP are indirectly created. The charged particles CP are not necessarily ions to be analyzed but reacted ions and ion cluster may be used as an example of the charged particles CP.

Other than the needle electrode, the ionization source 10 may be an ionization unit that includes a radioactive ionization source including nickel isotope (⁶³Ni) or americium isotope (²⁴¹Am) and ionizes the sample created by the radioactive ionization source or may be an ionization unit that includes an ultraviolet pulse laser oscillator and irradiates the sample with ultraviolet pulse laser beam such that the sample is directly subjected to ablation and ionized. The charged particles CP created by the ionization source 10 are transferred toward the detection cell 20 by gas flow of atmospheric gas (neutral buffer gas) such as atmosphere and carrier gas that is fed by the pump 30. The ionization source 10 of this embodiment is disposed on the upstream side (the left side in FIG. 1) of the detection cell 20 with respect to the direction of the gas flow fed by the pump 30.

The pump 30 is a component for transferring the atmospheric gas including the charged particles CP in the detection cell 20 along the direction of the gas flow. The pump 30 of this embodiment is disposed on the downstream side (the right side in FIG. 1) of the detection cell 20 with respect to the direction of the gas flow. Various kinds of gas feeding device that can transfer the charged particles CP created by the ionization source 10 to the detection cell 20, which will be described later, at predefined speed can be used as the pump 30. A gas feeding mechanism of the pump 30 is not particularly limited and may be a diaphragm pump, a rotary-blade type pump, a piston type pump, a rotary vane pump, or any other gas feeding devices. One example of the pump 30 may have a greatest discharge pressure from 150 kPa to 300 kPa and a flow rate from 3 L/min to 5 L/min, although the specific values depend on the size of the detection cell 20. A micro blower that fluctuates a diaphragm with a high frequency vibration (such as ultrasonic vibration) by a piezoelectric ceramic may be used as the pump 30. The micro blower that can supply gas with suppressing pulsation is preferably used as the pump 30.

The detection cell 20 is for separating (filtering) the charged particles CP created by the ionization source 10 according to a difference in the degree of mobility. The detection cell 20 includes a first electrode 21, a second electrode 22, a first substrate 23 (one example of a support body), a second substrate 24 (one example of the support body), a detection electrode 26 (a third electrode), a deflection electrode 27 (a sixth electrode), an upper electrode 28 (a fourth electrode), and a lower electrode 29 (a fifth electrode). The components of the detection cell 20 may be disposed in a chamber.

The first electrode 21 and the second electrode 22 are disposed opposite each other and configured as a pair of filter electrodes. The first electrode 21 and the second electrode 22 are plate electrodes that are disposed parallel to each other with a space therebetween. The charged particles CP are transferred in a space between the first electrode 21 and the second electrode 22. The space between the first electrode 21 and the second electrode 22 is a flow space 25. In the following, the direction in which the charged particles CP are transferred in the flow space 25 is defined as a first direction. The first direction is a transfer direction in which the charged particles CP are transferred. The first direction matches the X-axis direction. The flow space 25 includes an ion separation space (a drafting space). The first electrode 21 and the second electrode 22 are disposed on opposing surfaces (a first surface 23S and a second surface 24S) of the first substrate 23 and the second substrate 24, which will be described later. The first electrode 21 is connected to a first potential adjustment section 41, which will be described later, and the second electrode 22 is grounded.

The shape and the size of the first electrode 21 and the second electrode 22 are not particularly limited. The dimension of the first electrode 21 and the second electrode 22 measured in the direction along the X-axis direction is about 0.1cm or more (1cm or more, for example) and about 50cm or less (10cm or less, for example). The dimensions are not limited to the above values. The thicknesses of the first electrode 21 and the second electrode 22 is not particularly limited and is about 1μm or less, typically 600nm or less, and 400nm or less, for example. The thicknesses of the first electrode 21 and the second electrode 22 is about 50nm or more, typically 100nm or more, and 200nm or more, for example.

The distance (filter gap) between the first electrode 21 and the second electrode 22 is not strictly determined. With a filter gap being decreased, the intensity of the field (corresponding to a dispersion voltage which will be described later) that is created in the ion separation space can be effectively increased. With the filter gap being too small, an electric discharge or turbulent air flow are likely to occur in the space between the first electrode 21 and the second electrode 22. Therefore, the filter gap is preferably about 50μm or more and about 1mm or less.

Material of the first electrode 21 and the second electrode 22 is not particularly limited. Various kinds of electrically conductive materials may be used for the first electrode 21 and the second electrode 22 as long as the material can create an electric field between the electrodes 21, 22. Metal material, inorganic electrically conductive material, and organic electrically conductive material may be used. With an example to be analyzed and ions included in the example having metal corrosive properties, inorganic electrically conductive material or organic electrically conductive material may be preferably used as the electrically conductive material of the surfaces of the first electrode 21 and the second electrode 22. The metal material of the first electrode 21 and the second electrode 22 is not particularly limited. In producing the first electrode 21 and the second electrode 22 with the lithography technology using ArF excimer laser, one kind or an alloy of one kind selected from highly electrically conductive metals including gold (Au), copper (Cu), titanium (Ti), aluminum (Al), chrome (Cr), molybdenum (Mo), tantalum (Ta), and tungsten (W) or an alloy of two or more kinds selected from the highly electrically conductive metals may be used. The metal material may be disposed in layers of W/Ta, Ti/Al, Ti/Al/Ti or Cu/Ti from an upper layer to increase physical properties such as adhesiveness with respect to a base member (the first substrate 23 and the second substrate 24). Examples of the inorganic electrically conductive material include indium tin oxide (ITO), indium-zinc-oxide (IZO), and indium-gallium-zinc-oxide (IGZO). Examples of the organic electrically conductive material include polyacetylene and polythiophenes. The first electrode 21 and the second electrode 22 may include two or more of the metal material, the inorganic electrically conductive material, and the organic electrically conductive material that are disposed on top of each other.

The first substrate 23 is for supporting the first electrode 21 and other components. In this embodiment, the first electrode 21, the deflection electrode 27, and the upper electrode 28 are disposed on the first substrate 23 so as to be spaced from each other in the X-axis direction. The first substrate 23 has the first surface 23S (one example of a support surface) where the first electrode 21, the deflection electrode 27, and the upper electrode 28 are disposed. The second substrate 24 is for supporting the second electrode 22 and other components. In this embodiment, the second electrode 22, the detection electrode 26, and the lower electrode 29 are disposed on the second substrate 24 so as to be spaced from each other in the X-axis direction. The second substrate 24 has the second surface 24S (one example of the support surface) where the second electrode 22, the detection electrode 26, and the lower electrode 29 are disposed. The first substrate 23 and the second substrate 24 are disposed such that the first surface 23S and the second surface 24S are opposite each other. With respect to the transfer direction of the charged particles CP in the flow space 25, the upper electrode 28 and the lower electrode 29 are disposed on the most upstream side portions of the first substrate 23 and the second substrate 24, the first electrode 21 and the second electrode 22 are disposed on the downstream side of the upper electrode 28 and the lower electrode 29, and the detection electrode 26 and the deflection electrode 27 are disposed on the most downstream side portions. The shape of the first substrate 23 and the second substrate 24 is not particularly limited as long as the first electrode 21 and the second electrode 22 can be supported parallel to each other with having a predefined gap therebetween and the upper electrode 28 and the lower electrode 29 can be supported parallel to each other with having a predefined gap therebetween and the detection electrode 26 and the deflection electrode 27 can be supported parallel to each other with having a predefined gap therebetween. For instance, the first substrate 23 and the second substrate 24 may be integrally formed in a tubular shape (a square tubular shape, a circular tubular shape). In the following, the direction along the first surface 23S and the second surface 24S and perpendicular to (crossing) the first direction is defined as a second direction. The second direction matches the Y-axis direction in the drawings. In the following, the direction forwarding from the first electrode 21 toward the second electrode 22 is defined as a third direction. The third direction is a normal direction of the first surface 23S and the second surface 24S. The third direction matches the Z-axis direction in the drawings.

The first substrate 23 and the second substrate 24 of this embodiment may be made of various kinds of insulation materials having insulation properties. One example of the insulation material has a volume resistivity of 10⁷Ωcm or more (for example, 10¹⁰Ωcm or more, 10¹²Ωcm or more, 10¹⁵Ωcm or more) at a room temperature (25°C, for example). For example, organic material or inorganic material having the volume resistivity of the above range may be used as the insulation material. Although it is not limited thereto, the first substrate 23 and the second substrate 24 are flat glass plates in this embodiment because the electrodes can be preferably formed on the substrates 23, 24 with the lithography technology. The thicknesses of the first substrate 23 and the second substrate 24 are not particularly limited and may be about 0.1mm to 1mm (0.5mm or 0.7mm, for example).

The detection electrode 26 is a component that receives electric charges by the contact with the charged particles CP that are transferred to the detection cell 20. The detection electrode 26 is on the downstream side of the second electrode 22 with respect to the transfer direction of the charged particles CP in the flow space 25. The detection electrode 26 has a collection surface where the charged particles CP are received. The detection electrode 26 is connected to the control section 40. According to such a configuration, the control section 40 acquires the amount of charged particles CP that are received on the collection surface of the detection electrode 26.

The deflection electrode 27 is a component that makes the charged particles CP to head for the detection electrode 26 such that the charged particles CP that are transferred to the detection cell 20 are collected by the detection electrode 26. The deflection electrode 27 is disposed next to and on the downstream side of the first electrode 21 with respect to the transfer direction of the charged particles CP in the flow space 25. The deflection electrode 27 is disposed opposite the detection electrode 26. The deflection electrode 27 is connected to a second potential adjustment section 42, which will be described later. With the application of a voltage to the deflection electrode 27 by the second potential adjustment section 42, an electric field, which can make the charged particles CP to head for the detection electrode 26, is created between the detection electrode 26 and the deflection electrode 27. The space between the detection electrode 26 and the deflection electrode 27 is a detection space for detecting the charged particles CP that passed through the ion separation space.

The shape of the detection electrode 26 and the deflection electrode 27 is not particularly limited. Thicknesses of the detection electrode 26 and the deflection electrode 27 may be different from each other and about 1μm or less, and typically 600nm or less, and for example, 500nm or less, 400nm or less, and 200nm or less. Thicknesses of the detection electrode 26 and the deflection electrode 27 may be different from each other and about 10nm or more, and typically 50nm or more, and for example, 100nm or more. Material and configurations of the detection electrode 26 and the deflection electrode 27 may be similar to those of the first electrode 21 and the second electrode 22 previously described.

The upper electrode 28 and the lower electrode 29 are disposed opposite each other and configured as a pair of calibration electrodes. The upper electrode 28 and the lower electrode 29 have opposing surfaces that are parallel to each other. The upper electrode 28 and the lower electrode 29 are disposed on the upstream side of the first electrode 21 and the second electrode 22 with respect to the transfer direction of the charted particles CP in the flow space 25. The upper electrode 28 and the lower electrode 29 are disposed on the downstream side of the ionization source 10 with respect to the transfer direction of the charged particles CP in the flow space 25. The upper electrode 28 is connected to a pulse width modulation adjustment (PWM) section 43, which will be described later, and the lower electrode 29 is grounded.

The shape and the size of the upper electrode 28 and the lower electrode 29 are not particularly limited. The dimensions of the upper electrode 28 and the lower electrode 29 measured in the X-axis direction are smaller than the dimensions of the first electrode 21 and the second electrode 22 measured in the X-axis direction and greater than the dimensions of the detection electrode 26 and the deflection electrode 27 measured in the X-axis direction. Material and configurations (such as thickness) of the upper electrode 28 and the lower electrode 29 may be similar to those of the first electrode 21 and the second electrode 22 previously described. The distance between the upper electrode 28 and the lower electrode 29 may be same as the distance between the first electrode 21 and the second electrode 22.

The control section 40 is a component that controls driving of the analyzer 1. As illustrated in FIG. 2, the control section 40 is connected to the detection cell 20. More specifically, the control section 40 is connected to the first electrode 21, the second electrode 22, the detection electrode 26, the deflection electrode 27, the upper electrode 28, and the lower electrode 29 and configured to control operations thereof. The control section 40 of this embodiment is further connected to the ionization source 10 and the pump 30 and also connected to an external power for supplying power to the analyzer 1.

The control section 40 is configured as a microcomputer including an interface (I/F) that transmits and receives various kinds of information, a central processing unit (CPU) that executes instructions of a control program, a read only memory (ROM) that stores programs that are executed by the CPU, a random access memory (RAM) that is used as a working area for developing a program, a storing section M that stores various kinds of information, and a timer T having a clocking function. The ROM stores computer programs that are used to apply a voltage to each of the first potential adjustment section 41, the second potential adjustment section 42, and the PWM adjustment section 43, computer programs that are used to perform various kinds of analysis processing based on a database, a data table, and the detected amount of charged particles CP, a database, and a table. The ROM is not necessarily limited thereto. The storing section M stores ID information of an analysis target, information of the amount of charged particles CP that are detected, information used for the various kinds of analysis processing, and information related to analysis results.

The control section 40 includes the first potential adjustment section 41, the second potential adjustment section 42, the PWM adjustment section 43 (a calibration voltage supply section), a measurement section 44, an ionization source control section 45, and a flow amount adjustment section 46. Each of the sections may be configured as a hardware or functions of the sections may be exerted by CPU that performs a program.

The first potential adjustment section 41 is a component that adjusts a potential difference created between the first electrode 21 and the second electrode 22. The first potential adjustment section 41 of this embodiment is connected to the first electrode 21 and applies a potential to the first electrode 21. With the first potential adjustment section 41 creating a potential difference (a filter voltage) between the first electrode 21 and the second electrode 22, an electric field is created between the first electrode 21 and the second electrode 22. The ion mobility is constant in a low electric field regardless of the electric field intensity; however, the ion mobility changes according to the electric field intensity in a high electric field. The first potential adjustment section 41 typically includes a variable voltage generator such as a pulse voltage generator and is configured to generate a dispersion voltage (DV) having a rectangular waveform. The dispersion voltage DV applied between the first electrode 21 and the second electrode 22 is a bipolar pulse voltage that is able to have positive and negative polarities. The potential of a positive polarity and the potential of a negative polarity are typically switched asymmetrically. A voltage waveform is an asymmetric pulse waveform that alternately includes a period TH during which a voltage level is a high voltage level VH that creates a high electric field and a period TL during which a voltage level is a low voltage level VL that creates a low electric field. In such a voltage waveform, the time-averaged voltage is zero.

A flow of carrier gas (typically neutral) including the charged particles CP is created at a constant speed in the ion separation space between the first electrode 21 and the second electrode 22. With the first potential adjustment section 41 applying a voltage of the high voltage level VH, a high electric field is created in the ion separation space. With the first potential adjustment section 41 applying a voltage of the low voltage level VL, a low electric field is created in the ion separation space. The high electric field and the low electric field have different polarities. With the charged particles CP being transferred to the environment in which the asymmetric electric fields are alternately created, the charged particles CP are attracted by the first electrode 21 and the second electrode 22 alternately and move in a zig-zag manner. The charged particles CP that are directed and move toward the first electrode 21 or the second electrode 22 collide with the first electrode 21 or the second electrode 22 and cannot pass through the flow space 25. Only the charged particles CP that are kept in balance between the first electrode 21 and the second electrode 22 pass through the flow space 25 and can reach the detection electrode 26 that is on the downstream side. The ion type that passes through the flow space 25 can be determined as follows. The compensation voltage (CV) is applied by the first potential adjustment section 41 to superimpose the dispersion voltage DV between the first electrode 21 and the second electrode 22. The ion type that passes through the flow space 25 can be changed by changing the voltage value of the compensation voltage CV to be applied. The compensation voltage CV is a DC voltage. By changing the compensation voltage CV at a certain change rate and a certain period TCV for every predetermined dispersion voltage DV, ions of different movability can be transferred to the detection space sequentially.

The second potential adjustment section 42 is a component that creates a predefined potential difference between the detection electrode 26 and the deflection electrode 27. The second potential adjustment section 42 of this embodiment is connected to the deflection electrode 27 and applies a potential to the deflection electrode 27. The second potential adjustment section 42 adjusts a potential of the deflection electrode 27 to be high with respect to the detection electrode 26 if the charged particles CP transferred to the detection cell 20 are positive ions and adjusts the potential of the deflection electrode 27 to be low with respect to the detection electrode 26 if the charged particles CP transferred to the detection cell 20 are negative ions. Accordingly, the charged particles CP that pass through the ion separation space are directed toward the detection electrode 26.

The PWM adjustment section 43 is a component that adjusts a potential difference between the upper electrode 28 and the lower electrode 29. The PWM adjustment section 43 of this embodiment is connected to the upper electrode 28 and applies potential to the upper electrode 28. With the PWM adjustment section 43 creating a potential difference (a calibration voltage) between the upper electrode 28 and the lower electrode 29, an electric field is created between the upper electrode 28 and the lower electrode 29. With an electric field being created between the upper electrode 28 and the lower electrode 29, some of the charged particles CP that are between the upper electrode 28 and the lower electrode 29 move toward the lower electrode 29 and adhere to the lower electrode 29. Accordingly, the amount of charged particles CP that are transferred to the flow space 25 between the first electrode 21 and the second electrode 22 is adjusted. The PWM adjustment section 43 is configured to apply a PWM signal, which is a kind of a pulse signal, to the upper electrode 28 as the calibration voltage. The PWM signals have a constant amplitude and modulated pulse widths. The PWM adjustment section 43 is configured to adjust a duty ratio (the pulse width) that is a time period ratio of the ON period (the period while the high potential is supplied) and the OFF period (the period while the low potential is supplied) of the PWM signal. As the ON period of the PWM signal supplied to the upper electrode 28 is controlled to be longer by the PWM adjustment section 43 (the OFF period becomes shorter), the period while the electric field being created between the upper electrode 28 and the lower electrode 29 becomes longer and therefore, the amount of charged particles CP adhering to the lower electrode 29 tends to increase. On the other hand, as the ON period of the PWM signal supplied to the upper electrode 28 is controlled to be shorter by the PWM adjustment section 43 (the OFF period becomes longer), the period while the electric field being created between the upper electrode 28 and the lower electrode 29 becomes shorter and therefore, the amount of charged particles CP adhering to the lower electrode 29 tends to decrease.

The measurement section 44 is a component that detects the number of charged particles CP that reach the detection electrode 26. The measurement section 44 is connected to the detection electrode 26 and configured to detect the current value (a detection current) based on the amount of charged particles CP reaching the detection electrode 26 and convert the current value into a voltage value (a detection voltage) with a transimpedance circuit and obtain the amount of ions. The measurement section 44 may be configured not only to measure the amount of charged particles CP but also to determine quality and quantity of the charged particles CP in cooperation with the first potential adjustment section 41. The information relating to the amount of charged particles CP (including the detection current and the detection voltage) obtained by the measurement section 44 is stored in the storing section M, for instance.

The ionization source control section 45 is connected to the ionization source 10 and configured to control an operation of the ionization source 10. The ionization source control section 45 is configured to switch the polarity of the charged particles CP to be generated between positive ions and negative ions by switching the polarity of voltage applied to a needle electrode in the ionization source 10 between positive and negative. Although it is not limited thereto, with the ionization source control section 45 generating negative charged particles CP, the first potential adjustment section 41, the second potential adjustment section 42, and the PWM adjustment section 43 adjust the voltages to be applied to the first electrode 21, the deflection electrode 27, and the upper electrode 28 such that the negative charged particles CP pass through the flow space 25. With the ionization source control section 45 generating positive charged particles CP, the first potential adjustment section 41, the second potential adjustment section 42, and the PWM adjustment section 43 adjust the voltages to be applied to the first electrode 21, the deflection electrode 27, and the upper electrode 28 such that the positive charged particles CP pass through the flow space 25.

The flow amount adjustment section 46 is connected to the pump 30 and configured to control an operation of the pump 30. The flow amount adjustment section 46 is configured to control the timings of driving and stopping the pump 30 and the rotation speed of a fan of the pump 30 to adjust gas speed in the detection cell 20.

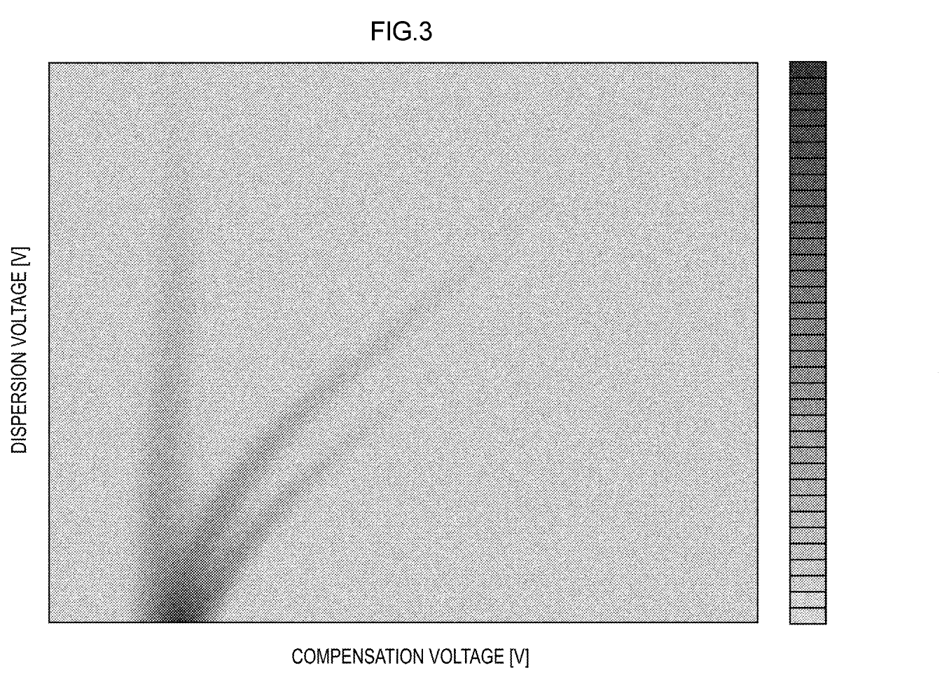

A FAIMS spectrum illustrated in FIG. 3 is obtained from the relation of the dispersion voltage DV and the compensation voltage CV, which are applied by the first potential adjustment section 41 between the first electrode 21 and the second electrode 22, and the electric signal from the detection electrode 26. FIG. 3 is a map graph representing the relation of the analysis condition (the dispersion voltage DV and the compensation voltage CV) and the mount of example ions (an ion current) that are detected based on the analysis condition. In FIG. 3, the vertical axis represents the dispersion voltages DV (the unit is “V”) and the horizontal axis represents the compensation voltages CV (the unit is “V”). With reference to the graph in FIG. 3, the analysis condition with the greater amount of detected example ions is illustrated with darker color. To obtain the FAIMS spectrum illustrated in FIG. 3, the dispersion voltage DV is set to a smallest value and scanning of the compensation voltage CV is performed with the compensation voltage CV being changed from the lowest voltage V_{CVL} to the highest voltage V_{CVH}. Then, the dispersion voltage DV is changed to the value higher than the smallest value and the compensation voltage CV is scanned again. The scanning of the compensation voltage CV is performed repeatedly until the dispersion voltage DV is set to the highest value.

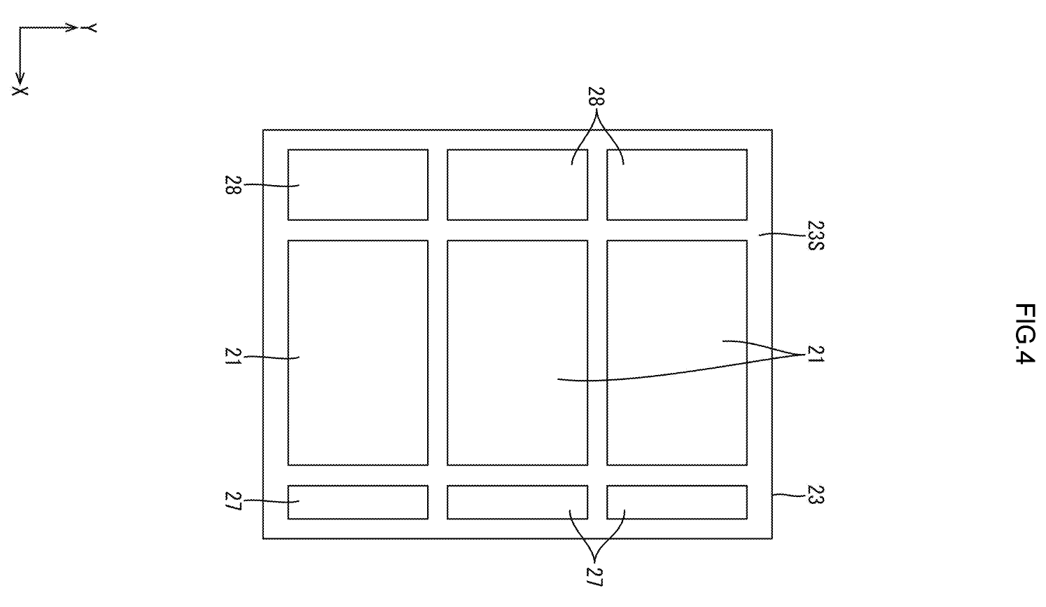

Next, the detailed configuration of the detection cell 20 will be described with reference to FIGS. 4 and 5. As illustrated in FIG. 4, the first substrate 23 of the detection cell 20 has a vertically long rectangular plan view shape. On the first substrate 23, the first electrode 21, the deflection electrode 27, and the upper electrode 28 are arranged at intervals in a line (in a row) along the X-axis direction. The first electrode 21 has a horizontally long rectangular plan view shape and is disposed in a middle of the first substrate 23 with respect to the X-axis direction. The deflection electrode 27 has a vertically long rectangular plan view shape and is disposed closer to one edge (on the downstream side) of the first substrate 23 with respect to the X-axis direction. The upper electrode 28 has a vertically long rectangular plan view shape and is disposed closer to another edge (on the upstream side) of the first substrate 23 with respect to the X-axis direction. The dimension (the width) of the upper electrode 28 measured in the X-axis direction is smaller than the dimension (the length) of the first electrode 21 measured in the X-axis direction and greater than the dimension (the width) of the deflection electrode 27 measured in the X-axis direction. The dimensions of the first electrode 21, the deflection electrode 27, and the upper electrode 28 measured in the Y-axis direction are substantially same and side edges of the first electrode 21, the deflection electrode 27, and the upper electrode 28 extending along the X-axis direction are aligned with each other. Three first electrodes 21 are arranged at intervals in the Y-axis direction (the second direction). Three deflection electrodes 27 are arranged at intervals in the Y-axis direction (the second direction). Three upper electrodes 28 are arranged at intervals in the Y-axis direction (the second direction). Namely, multiple electrode sets (three sets in this embodiment) each of which includes the first electrode 21, the deflection electrode 27, and the upper electrode 28 are arranged in the Y-axis direction.

As illustrated in FIG. 5, the second substrate 24 of the detection cell 20 has a vertically long rectangular plan view shape. On the second substrate 24, the second electrode 22, the detection electrode 26, and the lower electrode 29 are arranged at intervals in a line (in a row) along the X-axis direction. The second electrode 22 has a horizontally long rectangular plan view shape and is disposed in a middle of the second substrate 24 with respect to the X-axis direction. The detection electrode 26 has a vertically long rectangular plan view shape and is disposed closer to one edge (on the downstream side) of the second substrate 24 with respect to the X-axis direction. The lower electrode 29 has a vertically long rectangular plan view shape and is disposed closer to another edge (on the upstream side) of the second substrate 24 with respect to the X-axis direction. The dimension (the width) of the lower electrode 29 measured in the X-axis direction is smaller than the dimension (the length) of the second electrode 22 measured in the X-axis direction and greater than the dimension (the width) of the detection electrode 26 measured in the X-axis direction. The dimensions of the second electrode 22, the detection electrode 26, and the lower electrode 29 measured in the Y-axis direction are substantially same and side edges of the second electrode 22, the detection electrode 26, and the lower electrode 29 extending along the X-axis direction are aligned with each other. Three second electrodes 22 are arranged at intervals in the Y-axis direction. Three detection electrodes 26 are arranged at intervals in the Y-axis direction. Three lower electrodes 29 are arranged at intervals in the Y-axis direction. Namely, multiple electrode sets (three sets in this embodiment) each of which includes the second electrode 22, the detection electrode 26, and the lower electrode 29 are arranged in the Y-axis direction. The plan view size of the second electrode 22 is substantially same as that of the first electrode 21 and the second electrode 22 is disposed to overlap the first electrode 21 in a plan view. The plan view size of the detection electrode 26 is substantially same as that of the deflection electrode 27 and the detection electrode 26 is disposed to overlap the deflection electrode 27 in a plan view. The plan view size of the lower electrode 29 is substantially same as that of the upper electrode 28 and the lower electrode 29 is disposed to overlap the upper electrode 28 in a plan view.

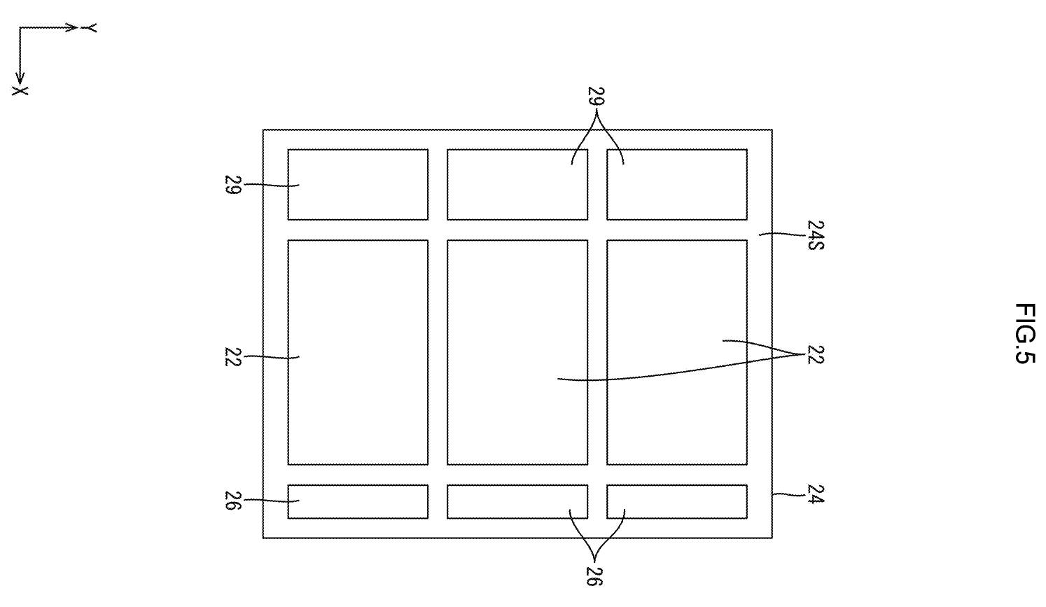

As illustrated in FIG. 6, the detection cell 20 of this embodiment includes multiple electrode groups (three groups in this embodiment) each of which includes the first electrode 21, the second electrode 22, the detection electrode 26, the deflection electrode 27, the upper electrode 28, and the lower electrode 29. Namely, the detection cell 20 is an array-type detection cell. As illustrated in FIG. 6, the three electrode groups of the detection cell 20, which is the array-type detection cell, include a first electrode group EG1, a second electrode group EG2, and a third electrode group EG3. The first electrode group EG1 is on the upper side in FIG. 6, the second electrode group EG2 is in a middle with respect to the upper-bottom direction in FIG. 6, and the third electrode group EG3 is on the lower side in FIG. 6. The detection cell 20, which is the array-type detection cell, may include dividing walls that define each of the electrode groups EG1 to EG3. The dividing wall may be between the first electrode group EG1 and the second electrode group EG2, which are adjacent to each other in the Y-axis direction, and between the second electrode group EG2 and the third electrode group EG3, which are adjacent to each other in the Y-axis direction. Accordingly, the spaces between the dividing walls where the electrode groups EG1 to EG3 respectively disposed are independent from each other. The ionization sources 10 (three ionization sources 10) are disposed for the detection cell 20. The ionization sources 10 are arranged at intervals in the Y-axis direction and the number of the ionization sources 10 is same as the number of electrode groups EG1 to EG3. The charged particles CP generated by the ionization sources 10 are supplied to the corresponding electrode groups EG1 to EG3 of the detection cell 20, respectively. The ionization sources 10 are configured as an array-type ion source.

With the charged particles CP being supplied from the ionization sources 10, which are configured as the array-type ion source, to the detection cell 20, which is the array-type detection cell, the charged particles CP can be detected by each of the electrode groups EG1 to EG3. By applying different dispersion voltages DV and different compensation voltages CV to the first electrodes 21 and the second electrodes 22 of the electrode groups EG1 to EG3 (with different analysis conditions), the different kinds of ions can be detected at the same time. Accordingly, the FAIMS spectrum illustrated in FIG. 3 can be obtained in a shorter time.

In the ionization sources 10, which are configured as the array-type ion source, the amounts of charged particles CP generated by the ionization sources 10 may be varied due to the individual differences of the needle electrodes. Further, there may be individual differences in the humidity and the density of the example ions (including example atoms and example molecules before ionization) that are supplied to the ionization sources 10. The amounts of charged particles CP generated by the ionization sources 10 may be varied due to such individual differences. Furthermore, the amount of charged particles CP passing through the flow space 25 between the first electrode 21 and the second electrode 22, which are the filter electrodes, may be varied due to the individual differences of the electrode groups EG1 to EG3 included in the detection cell 20, which is the array-type detection cell. The difference between potentials applied to the first electrode 21 and the second electrode 22 by the first potential adjustment section 41 may be same in all the electrode groups EG1 to EG3 and the amounts of charged particles CP supplied to the electrode groups EG1 to EG3 by the ionization sources 10 may be same. Even in such a case, the amount of charged particles CP passing through the flow space 25 may be varied due to the individual differences of the electrode groups EG1 to EG3 and the amounts of charged particles CP detected by the detection electrodes 26 may be different from each other.

In this respect, as illustrated in FIG. 1, the detection cell 20 of this embodiment includes the upper electrode 28 and the lower electrode 29. The upper electrode 28 is disposed on the upstream side of the first electrode 21 with respect to the transfer direction of the charged particles CP in the flow space 25 and a calibration voltage is applied to the upper electrode 28. The lower electrode 29 is disposed on the upstream side of the second electrode 22 with respect to the transfer direction of the charged particles CP in the flow space 25 and is opposed to and spaced from the upper electrode 28. With the calibration voltage being applied to the upper electrode 28, the charged particles CP adhere to the lower electrode 29. With such a configuration, with the calibration voltage being applied to the upper electrode 28, an electric field is created between the upper electrode 28 and the lower electrode 29 and at least some of the charged particles CP adhere to the lower electrode 29 by the electric field. By adjusting the calibration voltage that is applied to the upper electrode 28, the amount of charged particles CP passing through the space between the upper electrode 28 and the lower electrode 29 and reaching the flow space 25 between the first electrode 21 and the second electrode 22 can be controlled. Accordingly, the detection current detected by the detection electrode 26 can be calibrated. Even if the amount of charged particles CP that are generated by each ionization source 10 and supplied to each electrode group EG1 to EG3 is varied or the amount of charged particles CP that pass through the flow space 25 of each of the electrode groups EG1 to EG3 of the detection cell 20 is varied, the detection currents detected by the detection electrodes 26 are calibrated and equalized.

To reduce the variations caused in the amount of the charged particles CP generated by the ionization sources 10 and supplied to the respective electrode groups EG1 to EG3 and the variations caused in the charged particles CP passing through the flow spaces 25 in the respective electrode groups EG1 to EG3 of the detection cell 20, the voltage supplied by the first potential adjustment section 41 to the first electrodes 21 and the second electrodes 22 of the electrode groups EG1 to EG3 may be corrected, for instance. However, since the first electrode 21 and the second electrode 22 are supplied with high voltages and signals of a high frequency, it is difficult to correct such signals. In this embodiment, the detection current can be effectively calibrated with a simple method of applying the calibration voltage to the upper electrode 28.

Furthermore, the analyzer 1 of this embodiment includes the PWM adjustment section 43 that supplies a calibration voltage to the upper electrode 28 of the detection cell 20. The PWM adjustment section 43 is configured to supply the upper electrode 28 with signals with a calibration voltage having a constant amplitude and with a modulated pulse width. The PWM adjustment section 43 is configured to adjust the duty ratio of the PWM signal that is supplied to the upper electrode 28 of each electrode group EG1 to EG3 to calibrate the detection current. Accordingly, even if the amounts of charged particles CP that are generated by the ionization sources 10 and supplied to the electrode groups EG1 to EG3 vary or the amounts of charged particles CP that pass through the flow spaces 25 of the electrode groups EG1 to EG3 of the detection cell 20 vary, the detection currents detected by the detection electrodes 26 are calibrated and equalized.

This embodiment has the configuration described above. The method of detecting the charged particles CP with using the analyzer 1 (including the detection cell 20) will be described. First, the calibration voltage that is applied to the upper electrode 28 is determined as follows. In determining the calibration voltage, the first electrodes 21 and the second electrodes 22 are grounded and the first electrodes 21 and the second electrodes 22 are at a same potential and have no potential difference. Similarly, the upper electrodes 28 and the lower electrodes 29 are grounded. Then, the charged particles CP are generated by the ionization sources 10 and supplied to the flow spaces 25 of the detection cell 20. The charged particles CP supplied to each flow space 25 are collected by the detection electrode 26 of each of the electrode groups EG1 to EG3. Then, the detection current and the detection voltage are detected by the measurement section 44 that is connected to the detection electrodes 26 and each of the detection voltages is defined as a first detection voltage.

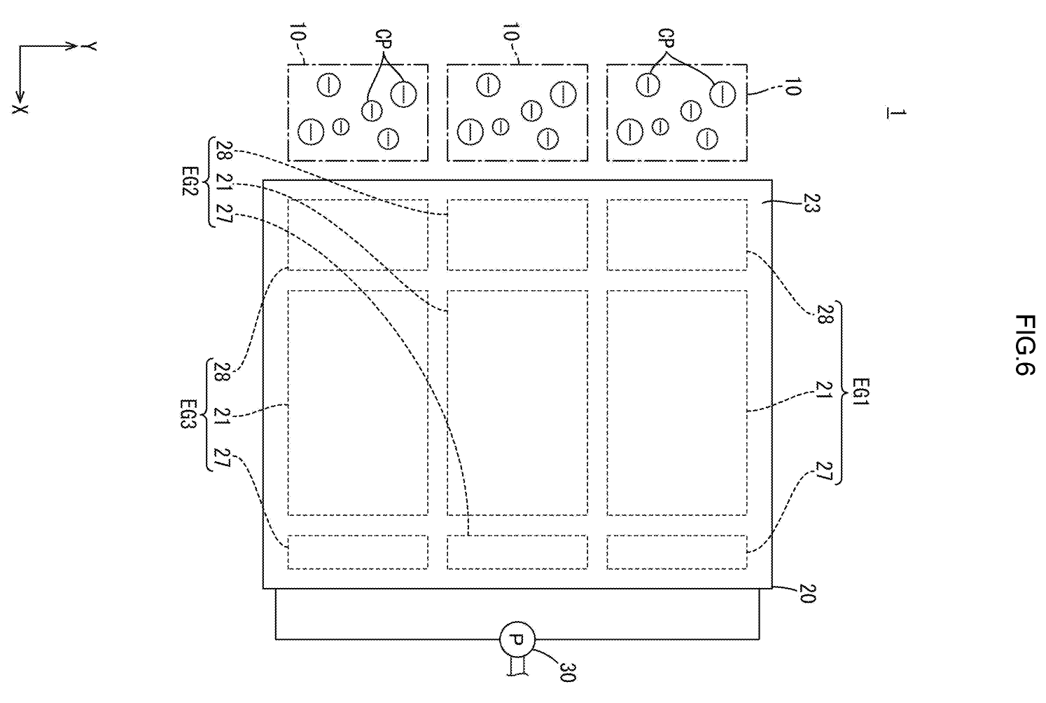

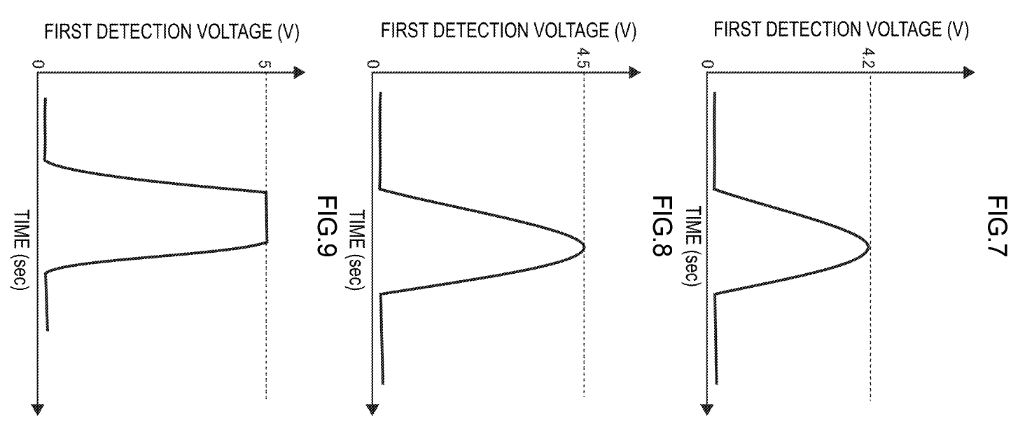

Examples of the first detection voltages, which are detected by the detection electrodes 26 of the electrode groups EG1 to EG3, are illustrated with graphs in FIGS. 7 to 9. The vertical axis in each of FIGS. 7 to 9 represents the first detection voltage (the unit is V) and the horizontal axis represents time (the unit is sec). FIG. 7 illustrates a graph that represents the first detection voltage detected by the detection electrode 26 of the first electrode group EG1. FIG. 8 illustrates a graph that represents the first detection voltage detected by the detection electrode 26 of the second electrode group EG2. FIG. 9 illustrates a graph that represents the first detection voltage detected by the detection electrode 26 of the third electrode group EG3. As illustrated in FIG. 7, the first detection voltage detected by the first electrode group EG1 is about 4.2 V. As illustrated in FIG. 8, the first detection voltage detected by the second electrode group EG2 is about 4.5 V. As illustrated in FIG. 9, the first detection voltage detected by the third electrode group EG3 is about 5 V. As the first detection voltage is higher, the amount of charged particles CP detected by the detection electrode 26 tends to be greater and as the first detection voltage is lower, the amount of charged particles CP detected by the detection electrode 26 tends to be smaller.

Next, differential voltages are obtained by subtracting a reference voltage from each of the first detection voltages. The reference voltage is lower than the smallest value of the first detection voltages. Specifically, with reference to the graphs in FIGS. 7 to 9, the smallest value of the first detection voltages is 4.2 V and therefore, the reference value is set to 4 V that is lower than 4.2 V. In setting the reference voltage, the voltage that is lower by 10 % than the average value of the first detection voltages may be defined as the reference voltage; however, in the following, the calibration voltages are calculated with the reference voltage being set to 4 V. As to the first electrode group EG1, the differential voltage is 0.2 V. As to the second electrode group EG2, the differential voltage is 0.5 V. As to the third electrode group EG3, the differential voltage is 1 V. The calibration voltage is determined based on the calculated differential voltage.

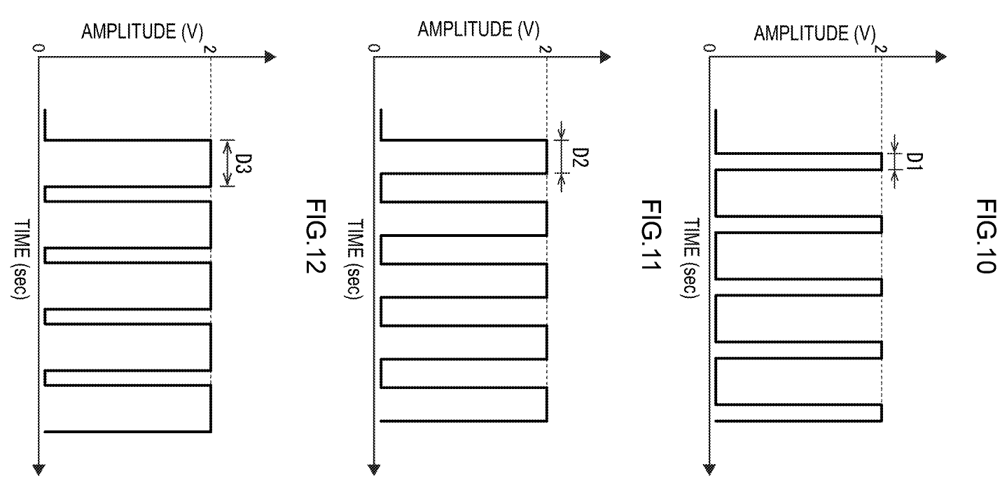

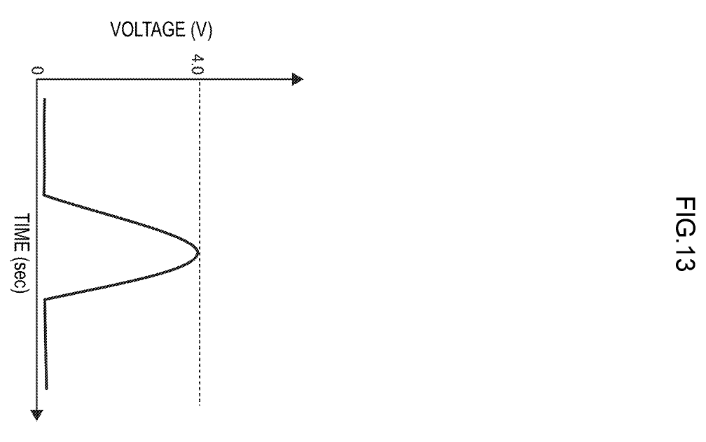

The PWM signal, which corresponds to the calibration voltage, is adjusted to have a higher duty ratio (a longer ON period) as the differential voltage is greater and has a lower duty ratio (a shorter ON period) as the differential voltage is smaller. More in detail, the duty ratio of the PWM signal, which corresponds to the calibration voltage, is adjusted such that with the first electrodes 21 and the second electrodes 22 being grounded, the charged particles CP are supplied to the flow spaces 25 of the detection cell 20 and the voltages detected by the detection electrodes 26 are equal to the reference voltage. Specifically, the PWM signals, which correspond to the calibration voltages in the electrode groups EG1 to EG3, are illustrated in FIGS. 10 to 12. The vertical axes in FIGS. 10 to 12 represent amplitudes of the PWM signals (the unit is V) and the horizontal axes represent time (the unit is sec). FIG. 10 illustrates a graph representing the waveform of the PWM signal that corresponds to the calibration voltage to be applied to the upper electrode 28 of the first electrode group EG1. FIG. 11 illustrates a graph representing the waveform of the PWM signal that corresponds to the calibration voltage to be applied to the upper electrode 28 of the second electrode group EG2. FIG. 12 illustrates a graph representing the waveform of the PWM signal that corresponds to the calibration voltage to be applied to the upper electrode 28 of the third electrode group EG3. With reference to FIGS. 10 to 12, the amplitudes of the PWM signals that correspond to the calibration voltages to be applied to the upper electrodes 28 of the electrode groups EG1 to EG3 are same and constant and are about 2 V. With reference to FIG. 10, the duty ratio of the PWM signal that corresponds to the calibration voltage to be applied to the upper electrode 28 of the first electrode group EG1 is about 4.7 %. With reference to FIG. 11, the duty ratio of the PWM signal that corresponds to the calibration voltage to be applied to the upper electrode 28 of the second electrode group EG2 is about 11.1 %. With reference to FIG. 12, the duty ratio of the PWM signal that corresponds to the calibration voltage to be applied to the upper electrode 28 of the third electrode group EG3 is about 80 %.

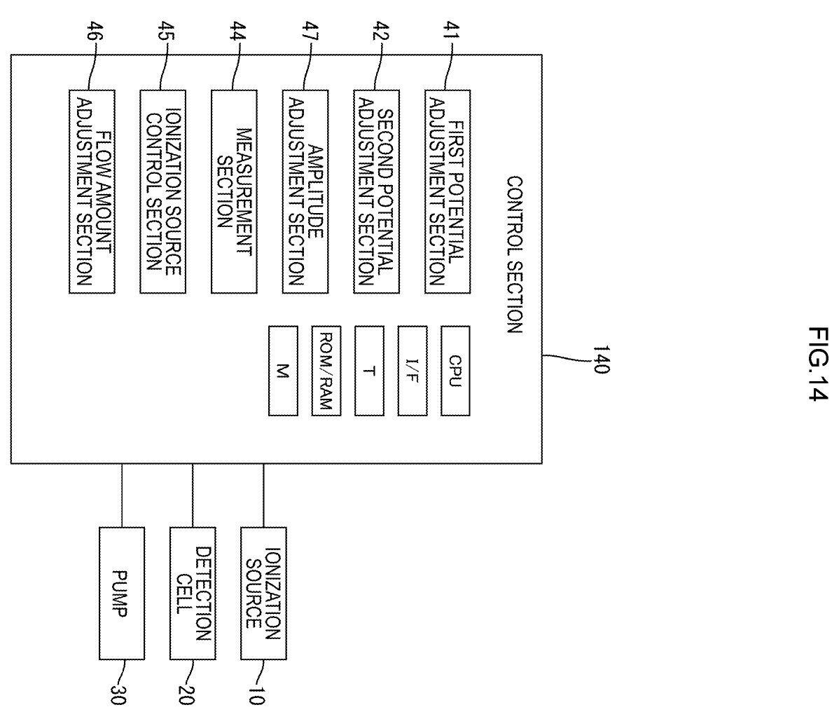

With the first electrodes 21 and the second electrodes 22 being grounded, the charged particles CP are supplied to the flow spaces 25 of the detection cell 20 and the PWM signals having the duty ratios D1 to D3 as illustrated in FIGS. 10 to 12 are applied to the upper electrodes 28 of the electrode groups EG1 to EG3, respectively. Then, as illustrated in FIG. 13, the voltages detected by the detection electrodes 26 are same as the reference volage that is 4 V. The vertical axis in FIG. 13 represents the voltage (the unit is V) that is detected by the detection electrode 26 and the horizontal axis represents the time (the unit is sec). FIG. 13 is a graph representing the voltage detected by the detection electrode 26 of each of the electrode groups EG1 to EG3.

After the calibration voltage is determined, the charged particles CP are actually detected with using the samples to be detected (actual measurement). In the actual measurement, the samples are supplied to the ionization sources 10 to generate the charged particles CP. The potential difference is created between the first electrode 21 and the second electrode 22 of each of the electrode groups EG1 to EG3 by the first potential adjustment section 41 and the calibration voltage is applied to the upper electrode 28 of each of the electrode groups EG1 to EG3 by the PWM adjustment section 43. When the charged particles CP supplied to the flow space 25 of each of the electrode groups EG1 to EG3 reach the space between the upper electrode 28 and the lower electrode 29, some of the charged particles CP adhere to the lower electrode 29. The amount of charged particles CP adhering to the lower electrode 29 is determined according to the calibration voltage applied to the upper electrode 28. As the duty ratio D1 to D3 of the PWM signal that corresponds to the calibration voltage is higher, the amount of charged particles CP adhering to the lower electrode 29 increases and as the duty ratio D1 to D3 of the PWM signal that corresponds to the calibration voltage is lower, the amount of charged particles CP adhering to the lower electrode 29 decreases.

Specifically, with reference to FIG. 10, the duty ratio D1 of the PWM signal, which corresponds to the calibration voltage applied to the upper electrode 28 of the first electrode group EG1, is lowest (about 4.7 %). Therefore, the amount of charged particles CP adhering to the lower electrode 29 of the first electrode group EG1 is smallest. With reference to FIG. 12, the duty ratio D3 of the PWM signal, which corresponds to the calibration voltage applied to the upper electrode 28 of the third electrode group EG3, is highest (about 80 %). Therefore, the amount of charged particles CP adhering to the lower electrode 29 of the third electrode group EG3 is greatest. With reference to FIG. 11, the duty ratio D2 of the PWM signal, which corresponds to the calibration voltage applied to the upper electrode 28 of the second electrode group EG2, is about 11.1 % and is higher than that of the first electrode group EG1 and lower than that of the third electrode group EG3. Therefore, the amount of charged particles CP adhering to the lower electrode 29 of the second electrode group EG2 is greater than that of the first electrode group EG1 and smaller than that of the third electrode group EG3.

By applying the calibration voltages to the upper electrodes 28 of the respective electrode groups EG1 to EG3, the amounts of charged particles CP supplied to the spaces between the first electrodes 21 and the second electrodes 22 are equalized. It is determined whether the charged particles CP passing through the space between the upper electrode 28 and the lower electrode 29 of each of the electrode groups EG1 to EG3 pass through the flow space 25 or not by the electric field created between the first electrode 21 and the second electrode 22. The charged particles CP passing through the flow spaces 25 are collected by the detection electrodes 26 with the voltage being applied to the deflection electrodes 27 by the second potential adjustment section 42. A second detection voltage and the detection current are detected according to the amount of charged particles CP collected by the detection electrode 26. By applying the calibration voltages to the respective upper electrodes 28 of the electrode groups EG1 to EG3, the second detection voltages and the detection currents are equalized and calibrated.

As previously described, the detection cell 20 (the detector) of this embodiment includes the first electrode 21, the second electrode 22, the detection electrode 26 (the third electrode), the upper electrode 28 (the fourth electrode), and the lower electrode 29 (the fifth electrode). The second electrode 22 is opposed to and spaced from the first electrode 21. The flow space 25 through which the charged particles CP to be detected are transferred is formed between the first electrode 21 and the second electrode 22. The detection electrode 26 is disposed on the downstream side of the first electrode 21 or the second electrode 22 with respect to the transfer direction of the charged particles CP in the flow space 25 and collects the charged particles CP. The upper electrode 28 is disposed on the upstream side of the first electrode 21 with respect to the transfer direction of the charged particles CP in the flow space 25 and the calibration voltage is applied to the upper electrode 28. The lower electrode 29 is disposed on the upstream side of the second electrode 22 with respect to the transfer direction of the charged particles CP in the flow space 25 and opposed to and spaced from the upper electrode 28. The charged particles CP adhere to the lower electrode 29 with the calibration voltage being applied to the upper electrode 28.

It is controlled whether the charged particles CP pass through the flow space 25 between the first electrode 21 and the second electrode 22 by the electric field created between the first electrode 21 and the second electrode 22. The charged particles CP passing through the flow space 25 are collected by the detection electrode 26 that is disposed on the downstream side of the first electrode 21 or the second electrode 22 with respect to the transfer direction of the charged particles CP in the flow space 25 and detected as the detection current. An electric field is created between the upper electrode 28 and the lower electrode 29, which are disposed on the upstream side of the first electrode 21 and the second electrode 22 with respect to the transfer direction, with the calibration voltage being applied to the upper electrode 28. At least some of the charged particles CP adhere to the lower electrode 29 by the electric field. By adjusting the calibration voltage applied to the upper electrode 28, the amount of charged particles CP passing through the space between the upper electrode 28 and the lower electrode 29 and reaching the flow space 25 between the first electrode 21 and the second electrode 22 can be controlled. Thus, the detection current can be calibrated.

The detection cell 20 of this embodiment further includes the first substrate 23 having the first surface 23S and the second substrate 24 having the second surface 24S that is opposed to and spaced from the first surface 23S. The first electrodes 21 are arranged, the second electrodes 22 are arranged, the detection electrodes 26 are arranged, the upper electrodes 28 are arranged, and the lower electrodes 29 are arranged at intervals in the second direction that is along the first surface 23S and the second surface 24S. The second direction crosses the first direction in which the charged particles CP are transferred in the flow space 25. The first electrodes 21 and the upper electrodes 28 are disposed on the first surface 23S. The second electrodes 22 and the lower electrodes 29 are disposed on the second surface 24S. The detection electrodes 26 are disposed on the first surface 23S or the second surface 24S. The electrode groups each of which includes the first electrode 21, the second electrode 22, the detection electrode 26, the upper electrode 28, and the lower electrode 29 are arranged at intervals in the second direction on the first surface 23S of the first substrate 23 and the second surface 24S of the second substrate 24. Thus, the electrodes are arrayed in the detection cell 20. Even with the amounts of charged particles CP supplied to the electrode groups being different from each other, the amount of charged particles CP passing through the space between the upper electrode 28 and the lower electrode 29 and reaching the flow space 25 between the first electrode 21 and the second electrode 22 in each of the electrode groups can be controlled by adjusting the calibration voltages applied to the upper electrodes 28. Thus, the detection currents are equalized.

The analyzer 1 (the detecting device) of this embodiment includes the detection cell 20 and the PWM adjustment section 43 (the calibration voltage supply section) that supplies the calibration voltage to the upper electrode 28. According to the analyzer 1 having such a configuration, the calibration voltage applied to the upper electrode 28 is adjusted by the PWM adjustment section 43 and the detection current can be calibrated.

The PWM adjustment section 43 supplies the upper electrodes 28 with signals having a constant amplitude and a modulated pulse width as the calibration voltages. With the pulse width of the signal supplied to each upper electrode 28 being modulated by the PWM adjustment section 43, the detection current can be calibrated.

The analyzer 1 of this embodiment further includes the ionization source 10 (the charged particle supply section) that supplies the charged particles CP to the detection cell 20. The detection cell 20 includes the first substrate 23 having the first surface 23S and the second substrate 24 having the second surface 24S that is opposed to and spaced from the first surface 23S. At least the first electrode 21 and the upper electrode 28 are disposed on the first substrate 23. At least the second electrode 22 and the lower electrode 29 are disposed on the second substrate 24. The first electrodes 21 are arranged, the second electrodes 22 are arranged, the detection electrodes 26 are arranged, the upper electrodes 28 are arranged, and the lower electrodes 29 are arranged at intervals in the second direction that is along the first surface 23S and the second surface 24S. The second direction crosses the first direction in which the charged particles CP are transferred in the flow space 25. The same number of ionization sources 10 as the number of the first electrodes 21, the second electrodes 22, the detection electrodes 26, the upper electrodes 28, and the lower electrodes 29 are arranged in the second direction. The electrode groups each of which includes the first electrode 21, the second electrode 22, the detection electrode 26, the upper electrode 28, and the lower electrode 29 are arranged at intervals in the second direction on the first surface 23S of the first substrate 23 and the second surface 24S of the second substrate 24. The charged particles CP are supplied to the electrode groups from the respective ionization sources 10. Even with the amounts of charged particles CP supplied from the ionization sources 10 being different from each other, the amount of charged particles CP passing through the space between the upper electrode 28 and the lower electrode 29 and reaching the flow space 25 between the first electrode 21 and the second electrode 22 in each of the electrode groups can be controlled by adjusting the calibration voltage applied to the upper electrode 28. Thus, the detection currents are equalized.

The first electrodes 21 and the upper electrodes 28 are disposed on the first surface 23S. The second electrodes 22 and the lower electrodes 29 are disposed on the second surface 24S. The detection electrodes 26 are disposed on the first surface 23S or the second surface 24S. The electrode groups each of which includes the first electrode 21, the second electrode 22, the detection electrode 26, the upper electrode 28, and the lower electrode 29 are arranged at intervals in the second direction on the first surface 23S of the first substrate 23 and the second surface 24S of the second substrate 24. Thus, in the detection cell 20 the electrodes are arrayed. Even with the amounts of charged particles CP supplied from the ionization sources 10 to the electrode groups being different from each other, the amount of charged particles CP passing through the space between the upper electrode 28 and the lower electrode 29 and reaching the flow space 25 between the first electrode 21 and the second electrode 22 in each of the electrode groups can be controlled by adjusting the calibration voltage applied to the upper electrode 28. Thus, the detection currents are equalized.

In the method of detecting the charged particles CP according to this embodiment, the detection cell 20 is used. The detection cell 20 includes the first electrode 21, the second electrode 22, the detection electrode 26, the upper electrode 28, and the lower electrode 29. The second electrode 22 is opposed to and spaced from the first electrode 21. The flow space 25 through which the charged particles CP to be detected are transferred is formed between the first electrode 21 and the second electrode 22. The detection electrode 26 is disposed on the downstream side of the first electrode 21 or the second electrode 22 with respect to the transfer direction of the charged particles CP in the flow space 25 and collects the charged particles CP. The upper electrode 28 is disposed on the upstream side of the first electrode 21 with respect to the transfer direction of the charged particles in the flow space 25 and the calibration voltage is applied to the upper electrode 28. The lower electrode 29 is disposed on the upstream side of the second electrode 22 with respect to the transfer direction of the charged particles CP in the flow space 25 and opposed to and spaced from the upper electrode 28. The charged particles CP adhere to the lower electrode 29 with the calibration voltage being applied to the upper electrode 28. In the method, the charged particles CP are supplied to the flow space 25 with no potential difference being between the first electrode 21 and the second electrode 22, the charged particles CP are collected by the detection electrode 26 to detect the first detection voltage, the calibration voltage is determined based on the differential voltage obtained by calculating difference between the first detection voltage and a predefined reference voltage, the charged particles CP are supplied to the flow space 25 with the potential difference being applied between the first electrode 21 and the second electrode 22 and the calibration voltage being applied to the upper electrode 28, and the charged particles CP are collected by the detection electrode 26 to detect the second detection voltage.

First, the calibration voltage applied to the upper electrode 28 is determined as follows. The charged particles CP are supplied to the flow space 25 with no potential difference being between the first electrode 21 and the second electrode 22 and the charged particles CP are collected by the detection electrode 26. Accordingly, the first detection voltage according to the amount of charged particles CP collected by the detection electrode 26 is detected. The differential voltage is obtained by calculating difference between the detected first detection voltage and the predefined reference voltage and the calibration voltage is determined based on the obtained differential voltage. The potential difference is applied between the first electrode 21 and the second electrode 22 and the charged particles CP are supplied to the flow space 25 with the calibration voltage being applied to the upper electrode 28. Then, an electric field is created between the upper electrode 28 and the lower electrode 29 that are disposed on the upstream side of the first electrode 21 and the second electrode 22 with respect to the transfer direction of the charged particles CP in the flow space 25. Therefore, at least some of the charged particles CP adhere to the lower electrode 29 by the electric field. It is controlled whether the charged particles CP passing through the space between the upper electrode 28 and the lower electrode 29 pass through the flow space 25 by the electric field created between the first electrode 21 and the second electrode 22. The charged particles CP passing through the flow space 25 are collected by the detection electrode 26 that is disposed on the downstream side of the first electrode 21 or the second electrode 22 with respect to the transfer direction of the charged particles CP in the flow space 25 and the second detection voltage (the detection current) according to the amount of collected charged particles CP is detected. Thus, the calibration voltage is determined based on the differential voltage obtained by subtracting the reference voltage from the first detection voltage and the calibration voltage is applied to the upper electrode 28. Accordingly, the amount of charged particles CP that pass through the space between the upper electrode 28 and the lower electrode 29 and reach the flow space 25 between the first electrode 21 and the second electrode 22 can be controlled. Thus, the detection current is calibrated.

### Second embodiment

A second embodiment will be described with reference to FIGS. 14 to 17. In the second embodiment, the signal of the calibration voltage is altered from that of the first embodiment. The configurations, operations, and effects same as those of the first embodiment will not be described.

As illustrated in FIG. 14, a control section 140 of this embodiment includes an amplitude adjustment section 47 (a calibration voltage supply section) instead of the PWM adjustment section 43 of the first embodiment. The amplitude adjustment section 47 supplies the upper electrode 28 with a pulse signal (a signal) having a constant pulse width and modulated amplitude as the calibration voltage. The amplitude adjustment section 47 is configured to adjust the amplitude of the pulse signal having a constant duty ratio that is a time period ratio of the ON period (the period while the high potential is supplied) and the OFF period (the period while the low potential is supplied). As the amplitude of the pulse signal supplied to the upper electrode 28 by the amplitude adjustment section 47 becomes larger, intensity of the electric field created between the upper electrode 28 and the lower electrode 29 increases and therefore, the amount of charged particles CP adhering to the lower electrode 29 tends to increase. On the other hand, as the amplitude of the pulse signal supplied to the upper electrode 28 by the amplitude adjustment section 47 becomes smaller, intensity of the electric field created between the upper electrode 28 and the lower electrode 29 decreases and therefore, the amount of charged particles CP adhering to the lower electrode 29 tends to decrease. Thus, by modulating the amplitude of the pulse signal supplied to the upper electrode 28 by the amplitude adjustment section 47, the detection current can be calibrated.

The amplitude of the pulse signal that corresponds to the calibration voltage applied to the upper electrode 28 is determined by the amplitude adjustment section 47 as follows. As described in the first embodiment, the first detection voltages in the electrode groups EG1 to EG3 are detected and the differential voltages are obtained by subtracting the reference voltage from the respective detected first detection voltages. The pulse signal that corresponds to the calibration voltage is adjusted such that as the differential voltage is higher, the amplitude becomes larger and as the differential voltage is lower, the amplitude becomes smaller. In detail, the amplitude of the pulse signal, which corresponds to the calibration voltage, is adjusted such that with the first electrodes 21 and the second electrodes 22 being grounded, the charged particles CP are supplied to the flow spaces 25 of the detection cell 20 and the voltages detected by the detection electrodes 26 are equal to the reference voltage.

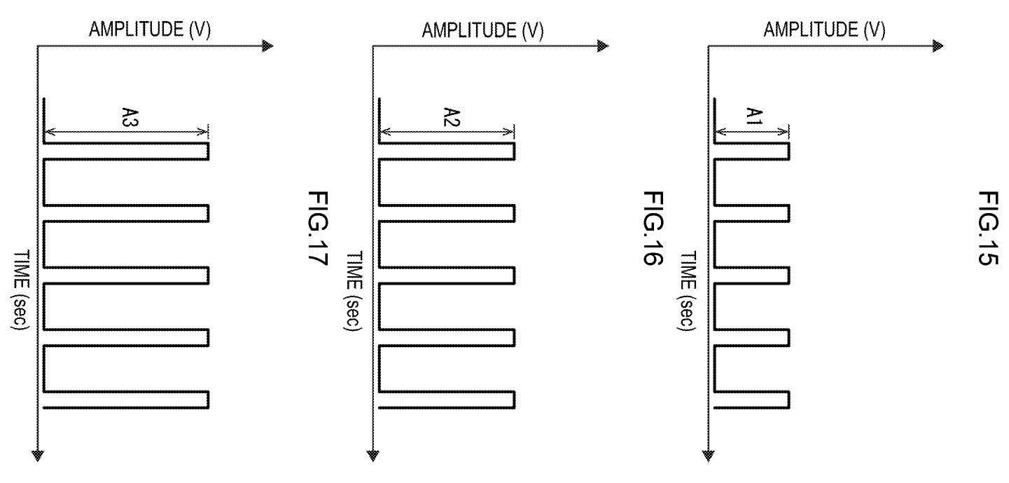

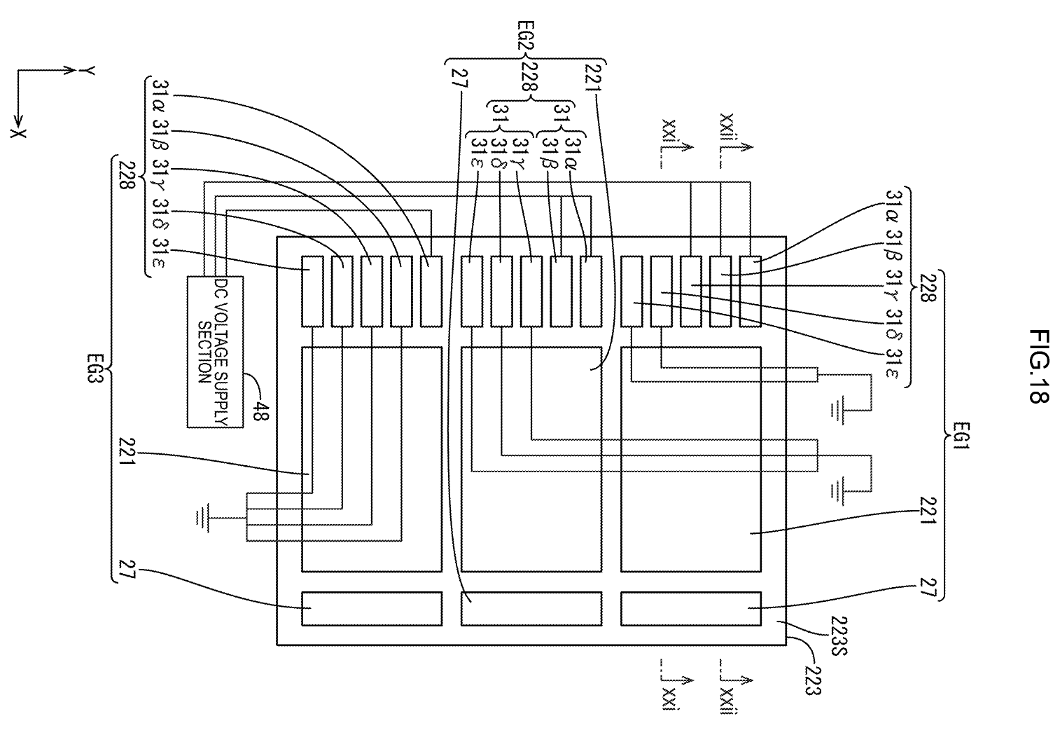

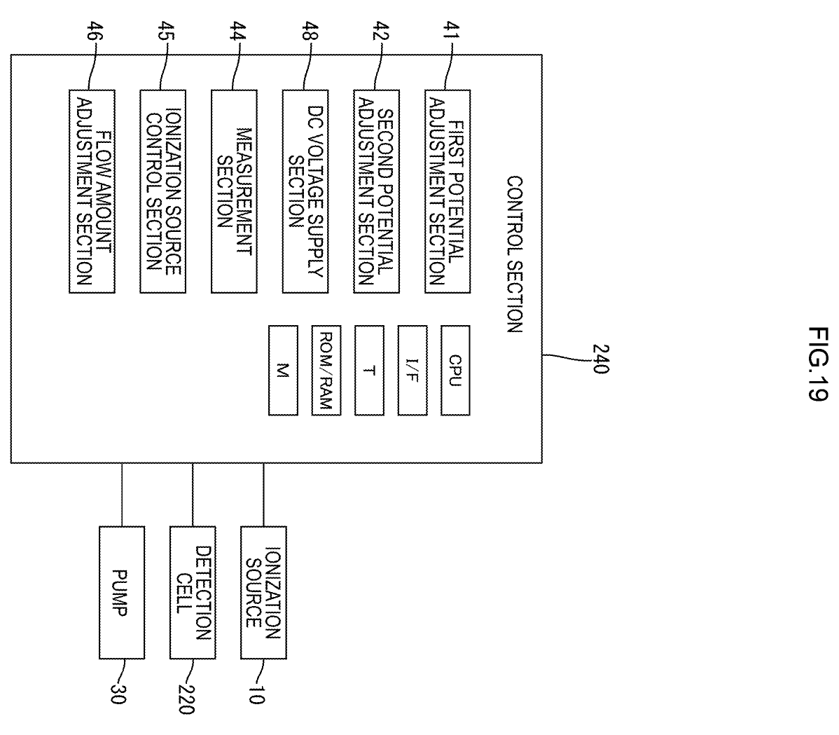

Specifically, the pulse signals, which correspond to the calibration voltages in the electrode groups EG1 to EG3, are illustrated in FIGS. 15 to 17. The vertical axes in FIGS. 15 to 17 represent amplitudes of the pulse signals (the unit is V) and the horizontal axes represent time (the unit is sec). FIG. 15 illustrates a graph representing the waveform of the pulse signal that corresponds to the calibration voltage to be applied to the upper electrode 28 of the first electrode group EG1. FIG. 16 illustrates a graph representing the waveform of the pulse signal that corresponds to the calibration voltage to be applied to the upper electrode 28 of the second electrode group EG2. FIG. 17 illustrates a graph representing the waveform of the pulse signal that corresponds to the calibration voltage to be applied to the upper electrode 28 of the third electrode group EG3. With reference to FIGS. 15 to 17, the pulse widths of the pulse signals that correspond to the calibration voltages to be applied to the upper electrodes 28 of the electrode groups EG1 to EG3 are same and constant. With reference to FIG. 15, the amplitude A1 of the pulse signal that corresponds to the calibration voltage to be applied to the upper electrode 28 of the first electrode group EG1 is smallest. The differential voltage is smallest in the first electrode group EG1. With reference to FIG. 17, the amplitude A3 of the pulse signal that corresponds to the calibration voltage to be applied to the upper electrode 28 of the third electrode group EG3 is largest. The differential voltage is largest in the third electrode group EG3. With reference to FIG. 16, the amplitude A2 of the pulse signal that corresponds to the calibration voltage to be applied to the upper electrode 28 of the second electrode group EG2 is larger than the amplitude A1 in the first electrode group EG1 and smaller than the amplitude A3 in the third electrode group EG3.

With the first electrodes 21 and the second electrodes 22 being grounded, the charged particles CP are supplied to the flow spaces 25 of the detection cell 20 and the pulse signals having the amplitudes A1 to A3 as illustrated in FIGS. 15 to 17 are applied to the upper electrodes 28 of the electrode groups EG1 to EG3, respectively. Then, as illustrated in FIG. 13, the voltages detected by the detection electrodes 26 are same as the reference voltage. After the calibration voltages are determined, the actual measurement is performed similarly to the first embodiment and the second detection voltages and the detection currents that are equalized and calibrated are detected.

As previously described, according to this embodiment, the amplitude adjustment section 47 supplies the upper electrodes 28 with signals having a constant pulse width and modulated amplitudes A1 to A3 as the calibration voltage. With the amplitudes of the signals supplied to the upper electrodes 28 being modulated by the amplitude adjustment section 47, the detection current can be calibrated.

### Third embodiment

A third embodiment will be described with reference to FIGS. 18 to 22. In the third embodiment, an upper electrode 228 has a configuration different from that of the first embodiment. The configurations, operations, and effects same as those of the first embodiment will not be described.

As illustrated in FIG. 18, the upper electrode 228 of this embodiment includes separated electrodes 31. The separated electrodes 31 are arranged at intervals in the Y-axis direction on a first surface 223S of a first substrate 223. The separated electrodes 31 have a laterally long rectangular plan view shape. Long sides and short sides of the separated electrodes 31 extend in the X-axis direction and the Y-axis direction, respectively. Therefore, no other separated electrode 31 is disposed between the separated electrodes 31 arranged in the Y-axis direction and a first electrode 221 that is disposed adjacent to and on the downstream side of the separated electrodes 31 with respect to the transfer direction in a flow space 225. The upper electrode 228 includes five separated electrodes 31. The five separated electrodes 31 include a first separated electrode 31α, a second separated electrode 31β, a third separated electrode 31γ, a fourth separated electrode 31δ, and a fifth separated electrode 31ɛ sequentially from the above in FIG. 18.

The five separated electrodes 31 are arranged at equal intervals in the Y-axis direction. The Y-axis length of an area where the five separated electrodes 31 are disposed is about same as the Y-axis length of an area where the first electrode 221 is disposed. The first electrode 221 is disposed on the downstream side of the separated electrodes 31 with respect to the transfer direction of the charged particles CP in the flow space 225. Specifically, the first separated electrode 31α has an X-axis side edge that extends along the X-axis direction and is on an opposite side of the second separated electrode 31β with respect to the Y-axis direction and the fifth separated electrode 31ɛ has an X-axis side edge that extends along the X-axis direction and is on an opposite side of the fourth separated electrode 31δ with respect to the Y-axis direction. The X-axis side edge of the first separated electrode 31α and the X-axis side edge of the fifth separated electrode 31ɛ are respectively aligned with an upper edge and a lower edge of the first electrode 221 extending along the X-axis direction.

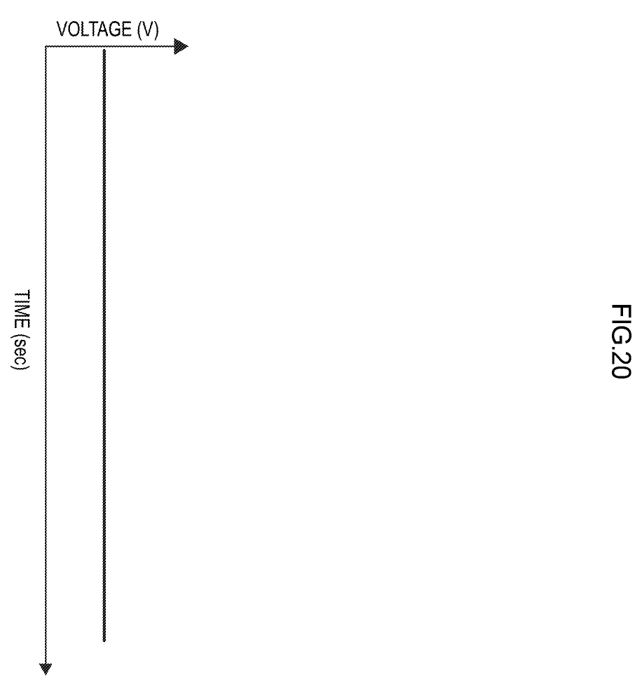

As illustrated in FIG. 19, a control section 240 of this embodiment includes a DC voltage supply section 48 (a calibrated voltage supply section) instead of the PWM adjustment section 43. The DC voltage supply section 48 supplies the upper electrode 228 with a DC voltage as the calibration voltage. As illustrated in FIG. 20, the DC voltage supplied to the upper electrodes 228 by the DC voltage supply section 48 is a constant voltage and does not change as time passes. FIG. 20 illustrates a graph representing the waveform of a DC voltage signal that corresponds to the calibration voltage to be applied to the upper electrode 228. The vertical axis in FIG. 20 represents the voltage (the unit is V) of the DC voltage signal and the horizontal axis represents the time (the unit is sec). The DC voltage supply section 48 selectively supplies the separated electrodes 31 of the upper electrode 228 with the DC voltage. In detail, the DC voltage supply section 48 supplies the DC voltage to some or all of the separated electrodes 31 and appropriately adjusts the number of separated electrodes 31 to be supplied with the DC voltage. The separated electrodes 31 that are not supplied with the DC voltage by the DC voltage supply section 48 are grounded.

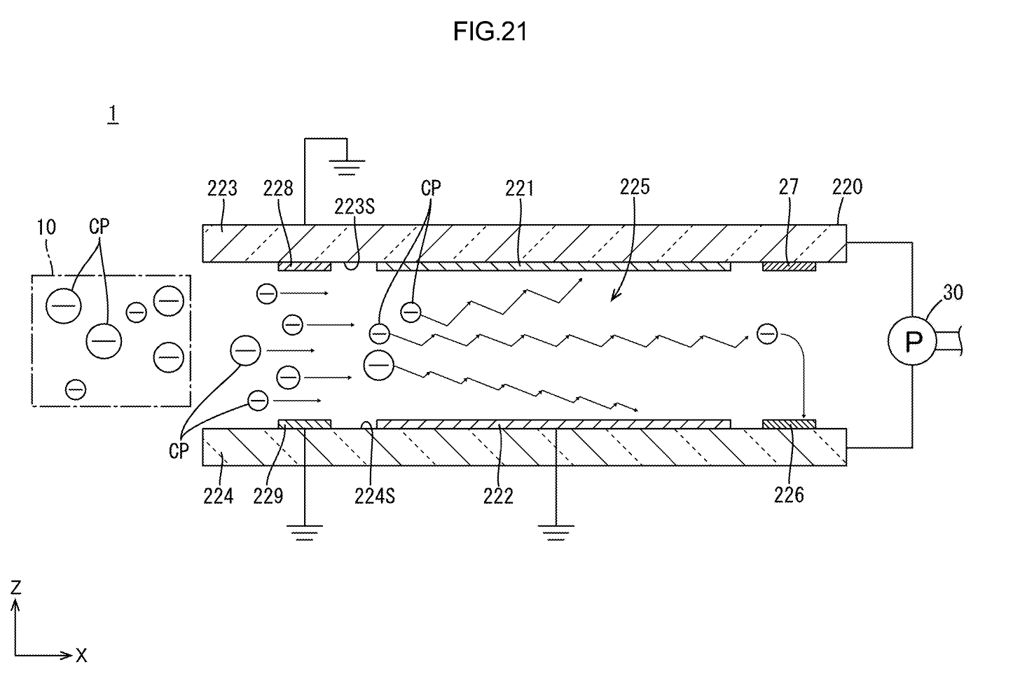

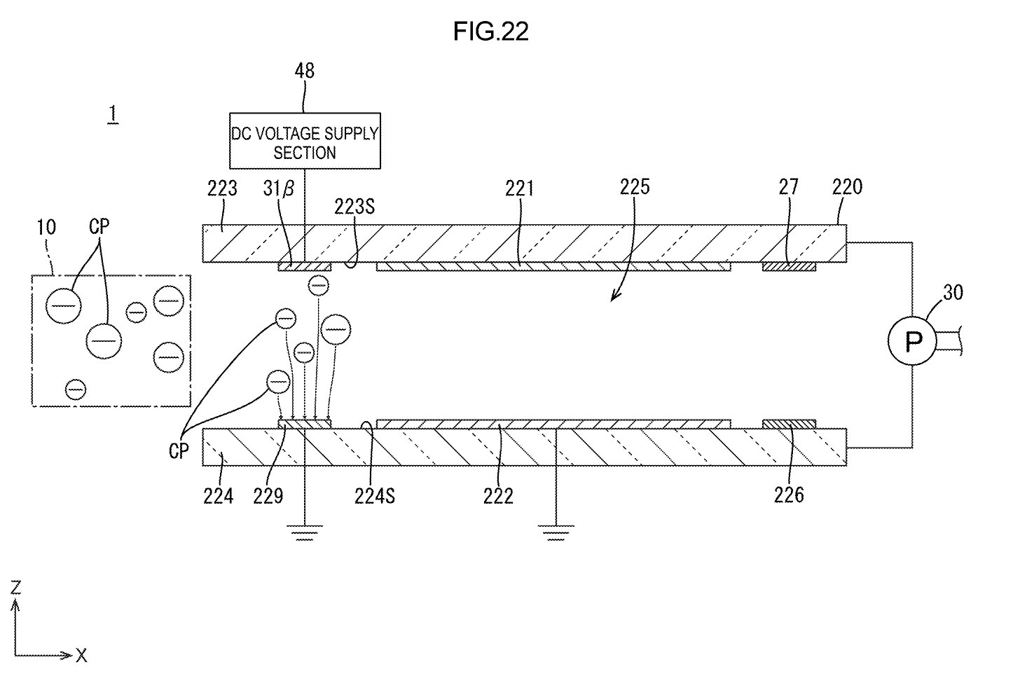

With the DC voltage being selectively supplied as the calibration voltage to the separated electrodes 31 by the DC voltage supply section 48, the amount of charged particles CP that reach the space between the first electrode 221 and the second electrode 222 is adjusted as follows. First, as illustrated in FIG. 21, the grounded separated electrode 31 of the upper electrode 228 has a same potential as the grounded lower electrode 229 and no potential difference is created between the grounded separated electrode 31 and the lower electrode 229. Therefore, in the space between the upper electrode 228 and the lower electrode 229, the charged particles CP supplied to a space corresponding to the grounded separated electrode 31 are less likely to adhere to the portion of the lower electrode 229 opposed to the grounded separated electrode 31 and are transferred to the space between the first electrode 221 and the second electrode 222. On the other hand, as illustrated in FIG. 22, a potential difference is created between the separated electrode 31 supplied with a DC voltage by the DC voltage supply section 48 and the grounded lower electrode 229 and therefore, an electric field is created therebetween. Therefore, in the space between the upper electrode 228 and the lower electrode 229, almost all of the charged particles CP supplied to the space corresponding to the separated electrode 31 supplied with the DC voltage adhere to the portion of the lower electrode 229 opposed to the separated electrode 31 supplied with the DC voltage and are less likely to be transferred to the space between the first electrode 221 and the second electrode 222 on the downstream side. Thus, in the space between the upper electrode 228 and the lower electrode 229, the Y-axis extending area through which the charged particles CP can pass changes according to the number of separated electrodes 31 that are supplied with the DC voltage. Therefore, by adjusting the number of separated electrodes 31 that are supplied with the DC voltage by the DC voltage supply section 48, the detection current can be calibrated.

The number of separated electrodes 31 that are supplied with the DC voltage by the DC voltage supply section 48 is determined as follows. As described in the first embodiment, the first detection voltages in the electrode groups EG1 to EG3 are detected and the differential voltages are obtained by subtracting the reference voltage from the respective detected first detection voltages. The number of separated electrodes 31 supplied with the DC voltage by the DC voltage supply section 48 is adjusted to increase as the differential voltage is higher and decrease as the differential voltage is lower. In detail, the number of separated electrodes 31 supplied with the DC voltage by the DC voltage supply section 48 is adjusted such that with the first electrodes 221 and the second electrodes 222 being grounded, the charged particles CP are supplied to the flow spaces 225 of the detection cell 220 and the voltages detected by the detection electrodes 226 are equal to the reference voltage.

Specifically, the number of separated electrodes 31 supplied with the DC voltage by the DC voltage supply section 48 in the electrode groups EG1 to EG3 will be described with reference to FIG. 18. Among the five separated electrodes 31 of the upper electrode 228 included in the third electrode group EG3, the DC voltage that corresponds to the calibration voltage is applied only to the first separated electrode 31α. Namely, in the third electrode group EG3 having the smallest differential voltage, the number of separated electrodes 31 supplied with the DC voltage by the DC voltage supply section 48 is one and smallest. The second separated electrode 31β, the third separated electrode 31γ, the fourth separated electrode 31δ, and the fifth separated electrode 31ɛ of the upper electrode 228 included in the third electrode group EG3 are grounded. Among the five separated electrodes 31 of the upper electrode 228 included in the first electrode group EG1, the DC voltage that corresponds to the calibration voltage is applied to the first separated electrode 31α, the second separated electrode 31β, and the third separated electrode 31γ. Namely, in the first electrode group EG1 having the greatest differential voltage, the number of separated electrodes 31 supplied with the DC voltage by the DC voltage supply section 48 is three and greatest. The fourth separated electrode 31δ and the fifth separated electrode 31ɛ of the upper electrode 228 included in the first electrode group EG1 are grounded. Among the five separated electrodes 31 of the upper electrode 228 included in the second electrode group EG2, the DC voltage that corresponds to the calibration voltage is applied to the first separated electrode 31α and the second separated electrode 31β. In the second electrode group EG2, the differential voltage is greater than that of the third electrode group EG3 and smaller than that of the first electrode group EG1 and the number of separated electrodes 31 supplied with the DC voltage by the DC voltage supply section 48 is two and is greater than that of the third electrode group EG3 and smaller than that of the first electrode group EG1. The third separated electrode 31γ, the fourth separated electrode 31δ, and the fifth separated electrode 31ɛ of the upper electrode 228 included in the second electrode group EG2 are grounded.

With the first electrodes 221 and the second electrodes 222 being grounded, the charged particles CP are supplied to the flow spaces 225 of the detection cell 220 and the DC voltage is selectively applied to the specific separated electrodes 31 by the DC voltage supply section 48. Then, the voltages detected by the detection electrodes 226 are equal to the reference voltage (refer to FIG. 13). After the calibration voltage is determined as described above, the actual measurement is performed similarly to the first embodiment and the second detection voltages and the detection currents that are equalized and calibrated are detected.

As previously described, according to this embodiment, the upper electrode 228 includes the separated electrodes 31 and the DC voltage supply section 48 (the calibration voltage supply section) selectively supplies the calibration voltage to the separated electrodes 31. With the DC voltage supply section 48 selectively supplying the calibration voltage to the separated electrodes 31, the detection current is calibrated.

The detection cell 220 includes the first substrate 223 having the first surface 223S and the second substrate 224 having the second surface 224S that is opposed to and spaced from the first surface 223S. At least the first electrodes 221 and the upper electrodes 228 are disposed on the first substrate 223. At least the second electrodes 222 and the lower electrodes 229 are disposed on the second substrate 224. The separated electrodes 31 are arranged at intervals in the second direction that is along the first surface 223S and the second surface 224S. The second direction crosses the first direction in which the charged particles CP are transferred in the flow space 225. The DC voltage supply section 48 selectively supplies the separated electrodes 31 with the DC voltage as the calibration voltage. The DC voltage supply section 48 selectively supplies the DC voltage as the calibration voltage to the separated electrodes 31 that are arranged at intervals in the second direction that is along the first surface 223S and the second surface 224S and crosses the first direction in which the charged particles CP are transferred in the flow space 225. Then, the charged particles CP adhere to the portion of the lower electrode 229 that is opposed to the separate electrode 31 supplied with the DC voltage. On the other hand, the charged particles CP do not adhere to the portion of the lower electrode 229 that is opposed to the separate electrode 31 supplied with no DC voltage. Namely, in the space between the upper electrode 228 and the lower electrode 229, the area through which the charged particles CP can pass changes according to the number of separated electrodes 31 that are supplied with the DC voltage. Therefore, by adjusting the number of separated electrodes 31 that are supplied with the DC voltage by the DC voltage supply section 48, the detection current can be calibrated.

### Fourth embodiment

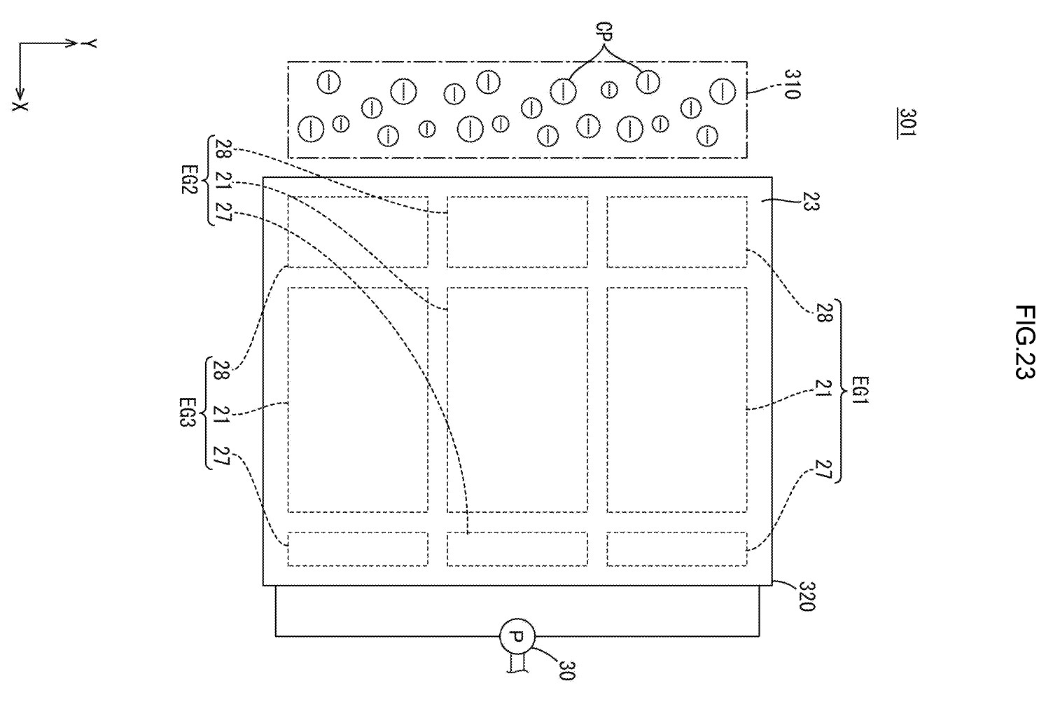

A fourth embodiment will be described with reference to FIG. 23. In the fourth embodiment, the number of ionization sources 310 differs from that of the first embodiment. The configurations, operations, and effects same as those of the first embodiment will not be described.

As illustrated in FIG. 23, an analyzer 301 of this embodiment includes one ionization source 310. The ionization source 310 extends in the Y-axis direction to be opposite the three electrode groups EG1 to EG3 included in a detection cell 320. The ionization source 310 is configured to supply the charged particles CP to the electrode groups EG1 to EG3. According to such a configuration, the operations and effects similar to those of the first embodiment can be obtained.

### Fifth embodiment

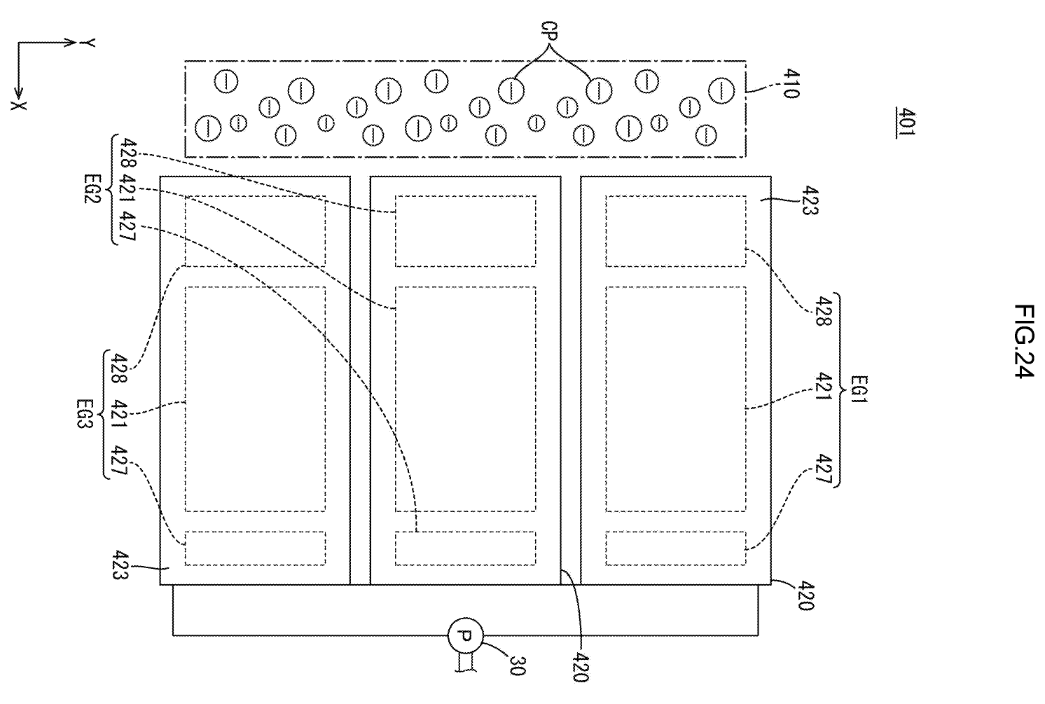

A fifth embodiment will be described with reference to FIG. 24. In the fifth embodiment, a detection cell 420 has a configuration different from that of the fourth embodiment. The configurations, operations, and effects same as those of the fourth embodiment will not be described.

As illustrated in FIG. 24, the detection cell 420 of this embodiment includes one first electrode 321, one second electrode 22, one detection electrode 26, one deflection electrode 427, one upper electrode 428, and one lower electrode 29. Namely, the detection cell 420 is one-set type detection cell that includes only one electrode group. Multiple (three in this embodiment) detection cells 420, which are one-set type detection cells, are arranged at intervals in the Y-axis direction. The detection cells 420 are supplied with the charged particles CP from an ionization source 410.

In an analyzer 401 including the detection cells 420, the amounts of charged particles CP supplied to the detection cells 420 may vary and each of the detection cells 420 may have different performance. In this respect, by adjusting the calibrating voltage applied to the upper electrode 428 of each detection cell 420, the amount of charged particles CP passing through the space between the upper electrode 428 and the lower electrode 429 and being transferred to the flow space 25 between the first electrode 421 and the second electrode 22 can be controlled in each detection cell 420. Thus, the detection currents are equalized.

As previously described, according to this embodiment, the detection cell 420 includes a first substrate 423 having a first surface and a second substrate 424 having a second surface that is opposed to and spaced from the first surface. At least the first electrode 421 and the upper electrode 428 are disposed on the first substrate 423. At least the second electrode 422 and the lower electrode 429 are disposed on the second substrate 424. The detection cells 420 are arranged at intervals in the second direction that is along the first surface and the second surface and crosses the first direction in which the charged particles CP are transferred in the flow space 25. Even with the amounts of charged particles CP supplied to the detection cells 420 may vary or each of the detection cells 420 may have different performance, the amount of charged particles CP that pass through the space between the upper electrode 428 and the lower electrode 29 and reach the flow space 25 between the first electrode 421 and the second electrode 22 in each detection cell 420 can be controlled by adjusting the calibration voltage applied to the upper electrode 428 of each detection cell 420. Thus, the detection currents are equalized.

### Sixth embodiment

A sixth embodiment will be described with reference to FIG. 25. In the sixth embodiment, a detection cell 520 has a configuration different from that of the fourth embodiment. The configurations, operations, and effects same as those of the fourth embodiment will not be described.

As illustrated in FIG. 25, the detection cell 520 of this embodiment includes a first electrode 521, a second electrode 22, a deflection electrode 527, an upper electrode 528, and a lower electrode 29. Namely, an analyzer 501 of this embodiment is a one-set type detection cell similar to that of the fifth embodiment. The analyzer 501 of this embodiment includes only one detection cell 520 which is a one-set type detection cell. According to such a configuration, the operations and effects similar to those of the first embodiment can be obtained.

### Seventh embodiment

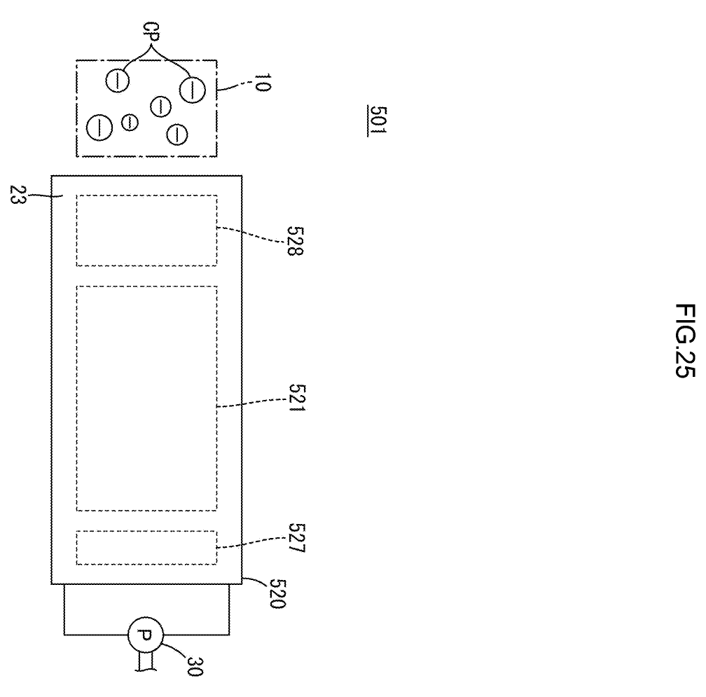

A seventh embodiment will be described with reference to FIG. 26. In the seventh embodiment, a mobility analyzer 601 has a configuration different from that of the first embodiment. The configurations, operations, and effects same as those of the first embodiment will not be described.

As illustrated in FIG. 26, the mobility analyzer 601 of this embodiment includes a compressor 631 instead of the pump 30 of the first embodiment. The compressor 631 is for creating compressed air and connected to an ionization source 610. The compressor 631 is on the upstream side of the ionization source 610. The compressor 631 supplies the created compressed air to the ionization source 610. By supplying the compressed air from the compressor 631 to the ionization source 610, air flows from the upstream side toward the downstream side in the flow space 25 (refer to FIG. 1) of a detection cell 620.

### Eighth embodiment

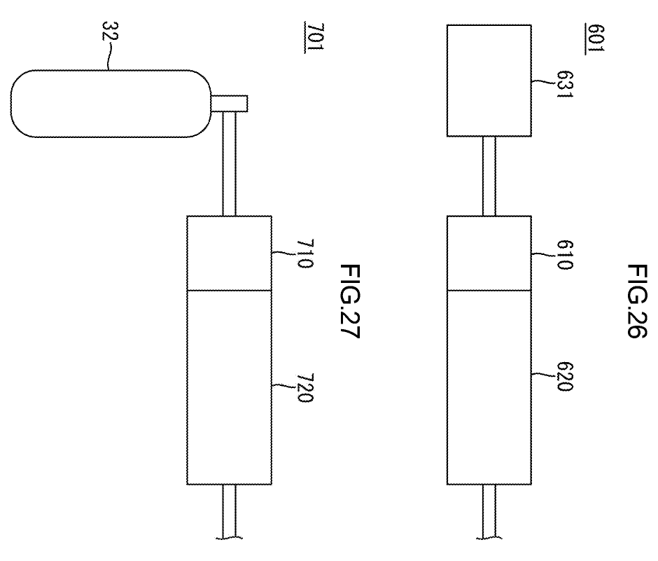

An eighth embodiment will be described with reference to FIG. 27. In the eighth embodiment, a mobility analyzer 701 has a configuration different from that of the first embodiment. The configurations, operations, and effects same as those of the first embodiment will not be described.

As illustrated in FIG. 27, the mobility analyzer 701 of this embodiment includes a dry air cylinder 32 instead of the pump 30 of the first embodiment. The dry air cylinder 32 is filled with compressed dry air that is air from which moisture is removed and compressed. The dry air cylinder 32 is connected to an ionization source 710 and on the upstream side of the ionization source 710. The dry air cylinder 32 supplies dry air to the ionization source 710. By supplying compressed air from the dry air cylinder 32 to the ionization source 710, air flows from the upstream side toward the downstream side in the flow space 25 (refer to FIG. 1) of a detection cell 720.

### Ninth embodiment

A ninth embodiment will be described with reference to FIG. 28. In the ninth embodiment, a mobility analyzer 801 has a configuration different from that of the first embodiment. The configurations, operations, and effects same as those of the first embodiment will not be described.

As illustrated in FIG. 28, the mobility analyzer 801 of this embodiment includes a compressor 831 in addition to a pump 830, which has a same configuration of the pump 30 of the first embodiment. The compressor 831 is same as the compressor 631 of the seventh embodiment and connected to an ionization source 810. The compressor 831 is on the upstream side of the ionization source 810. By driving the compressor 831 connected to the ionization source 810 on the upstream side and the pump 830 connected to a detection cell 820 on the downstream side, air flows from the upstream side toward the downstream side in the flow space 25 (refer to FIG. 1) of the detection cell 820.

### Tenth embodiment

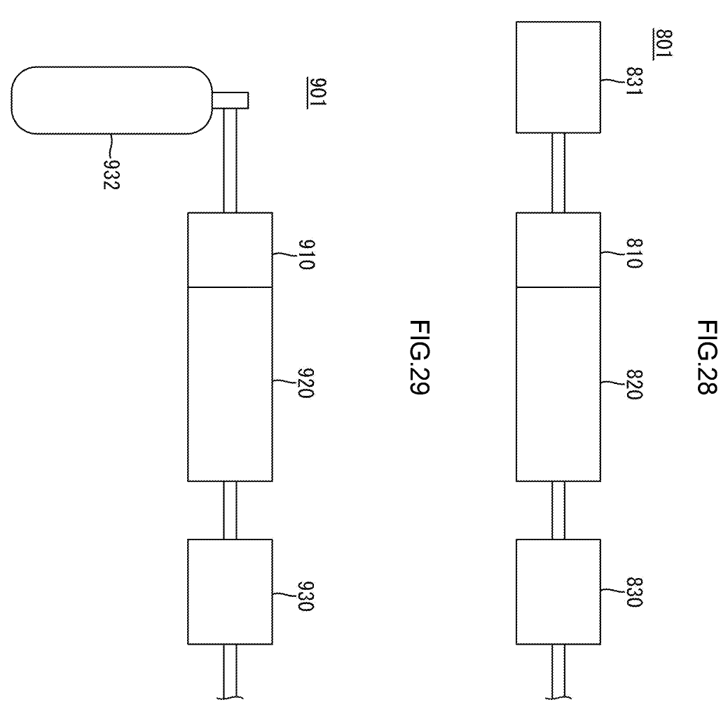

A tenth embodiment will be described with reference to FIG. 29. In the tenth embodiment, a mobility analyzer 901 has a configuration different from that of the first embodiment. The configurations, operations, and effects same as those of the first embodiment will not be described.

As illustrated in FIG. 29, the mobility analyzer 901 of this embodiment includes a dry air cylinder 932 in addition to a pump 930 having a same configuration as the pump 30 of the first embodiment. The dry air cylinder 932 has a same configuration and operation as the dry air cylinder 32 of the eighth embodiment and is connected to an ionization source 910 on the upstream side. By driving the dry air cylinder 932 connected to the ionization source 910 on the upstream side and the pump 930 connected to the detection cell 920 on the downstream side, air flows from the upstream side toward the downstream side in the flow space 25 (refer to FIG. 1) of a detection cell 920.

### Eleventh embodiment

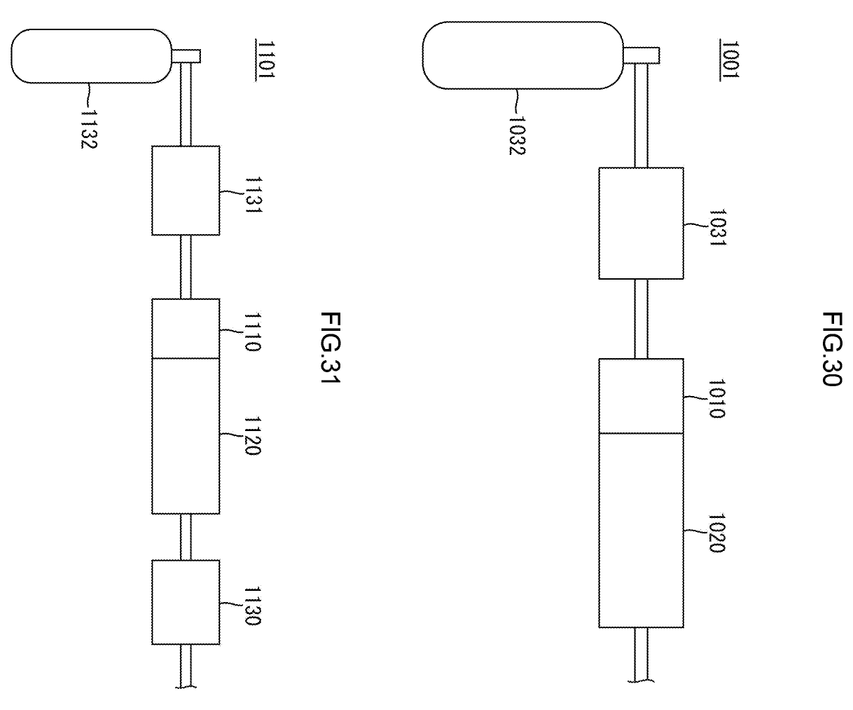

An eleventh embodiment will be described with reference to FIG. 30. In the eleventh embodiment, a mobility analyzer 1001 has a configuration different from that of the first embodiment. The configurations, operations, and effects same as those of the first embodiment will not be described.

As illustrated in FIG. 30, the mobility analyzer 1001 of this embodiment includes a compressor 1031 and a dry air cylinder 1032 instead of the pump 30 of the first embodiment. The compressor 1031 has same configuration and operation as the compressor 631 of the seventh embodiment and is connected to an ionization source 1010 on the upstream side. The dry air cylinder 1032 has same configuration and operation as the dry air cylinder 32 of the eighth embodiment and is connected to the compressor 1031 on the upstream side. By driving the compressor 1031 connected to the ionization source 1010 on the upstream side and the dry air cylinder 1032 connected to the compressor 1031 on the upstream side, air flows from the upstream side toward the downstream side in the flow space 25 (refer to FIG. 1) of a detection cell 1020.

### Twelfth embodiment

A twelfth embodiment will be described with reference to FIG. 31. In the twelfth embodiment, a mobility analyzer 1101 has a configuration different from that of the first embodiment. The configurations, operations, and effects same as those of the first embodiment will not be described.

As illustrated in FIG. 31, the mobility analyzer 1101 of this embodiment includes a compressor 1131 and a dry air cylinder 1132 in addition to a pump 1130 having same configuration and operation as that of the first embodiment. The compressor 1131 has same configuration and operation as the compressor 631 of the seventh embodiment and is connected to an ionization source 1110 on the upstream side. The dry air cylinder 1132 has same configuration and operation as the dry air cylinder 32 of the eighth embodiment and is connected to the compressor 1131 on the upstream side. By driving the compressor 1131 connected to the ionization source 1110 on the upstream side, the dry air cylinder 1132 connected to the compressor 1131 on the upstream side, and the pump 1130 connected to a detection cell 1120 on the downstream side, air flows from the upstream side toward the downstream side in the flow space 25 (refer to FIG. 1) of the detection cell 1120.

### Other embodiments

The technology described herein is not limited to the embodiments described above and illustrated by the drawings. For example, the following embodiments will be included in the technical scope of the present technology.
(1) The relation of the dimensions of the upper electrode 28, 228, 428, 528, the first electrode 21, 221, 421, 521, and the deflection electrode 27, 427, 527 measured in the X-axis direction may be altered as appropriate from that illustrated in the drawings. Similarly, the relation of the dimensions of the lower electrode 29, 229, the second electrode 22, 222, and the detection electrode 26, 226 measured in the X-axis direction may be altered as appropriate from that illustrated in the drawings.
(2) The first electrode 21, 221, 421, 521, the deflection electrode 27, 427, 527, and the upper electrode 28, 228, 428, 528 may have a different dimension measured in the Y-axis direction and the side edges thereof along the X-axis direction may not be aligned with each other. Similarly, the second electrode 22, 222, the detection electrode 26, 226, and the lower electrode 29, 229 may have a different dimension measured in the Y-axis direction and the side edges thereof along the X-axis direction may not be aligned with each other.
(3) The upper electrode 28, 228, 428, 528 and the lower electrode 29, 229 may have a different plan view size. Similarly, the first electrode 21, 221, 421, 521 and the second electrode 22, 222 may have a different plan view size. The detection electrode 26, 226 and the deflection electrode 27, 427, 527 may have a different plan view size.
(4) In the configurations of the first embodiment to the third embodiment, the number of electrode groups included in the detection cell 20, 220 may be two or four or more.
(5) In the configurations of the first embodiment to the third embodiment, the number of ionization sources 10 may be one, two, or four or more.
(6) In the configuration of the third embodiment, the PWM adjustment section 43 or the amplitude adjustment section 47 may be included instead of the DC voltage supply section 48.
(7) In the configuration of (6), the separated electrodes 31 may be arranged at intervals in the X-axis direction. The separated electrodes 31 may be arranged at intervals in the X-axis direction and the Y-axis direction.
(8) In the configuration of the third embodiment, some of the separated electrodes 31 may have a different plan view size from others.
(9) In the configuration of the third embodiment, the number of separated electrodes 31 (the number of partitions of the upper electrode 228) may be four or less or six or more.
(10) The configuration of the fourth embodiment or the sixth embodiment may be combined with the configuration of the second embodiment or the third embodiment.
(11) In the configuration of the fifth embodiment, the detection cell 20, 220 of the first embodiment to the third embodiment may be used. Namely, multiple array-type detection cells each of which includes electrode groups may be arranged at intervals in the Y-axis direction.
(12) In the configuration of the fifth embodiment, the same number of ionization sources 410 as the detection cells 420 may be included.
(13) In the configuration of the fifth embodiment, the number of detection cells 420 may be two or four or more.
(14) The detection electrodes 26, 226 may be and the deflection electrodes 27, 427, 527 may be arranged at intervals in the Y-axis direction.
(15) The second electrode 22, 222 may be applied with the dispersion voltage DV and the compensation voltage CV. In such a configuration, the first electrode 21, 221, 421, 521 may be grounded.
(16) The first electrode 21, 221, 421, 521 may be applied with the compensation voltage CV and the second electrode 22, 222 may be applied with the dispersion voltage DV.
(17) The analyzer may include an analysis method system other than the FAIMS system.
(18) The configuration of each of the seventh to the twelfth embodiments may be combined with the configuration of one of the second to the sixth embodiments.

1. A detector comprising:
a first electrode;
a second electrode opposed to and spaced from the first electrode to form a flow space of charged particles between the first electrode and the second electrode, the charged particles being transferred in the flow space in a first direction;
a third electrode disposed on a downstream side of the first electrode or the second electrode with respect to the first direction and collecting the charged particles;
a fourth electrode disposed on an upstream side of the first electrode with respect to the first direction and applied with a calibration voltage; and
a fifth electrode that is disposed on the upstream side of the second electrode with respect to the first direction and opposed to and spaced from the fourth electrode, the fifth electrode to which the charged particles adhere with the fourth electrode being applied with the calibration voltage.

2. The detector according to claim 1, further comprising:
a first substrate having a first surface; and
a second substrate having a second surface that is opposed to and spaced from the first surface, wherein
the first electrode includes first electrodes that are arranged at intervals in a second direction crossing the first direction and being along the first surface and the second surface,
the second electrode includes second electrodes that are arranged at intervals in the second direction,
the third electrode includes third electrodes that are arranged at intervals in the second direction,
the fourth electrode includes fourth electrodes that are arranged at intervals in the second direction,
the fifth electrode includes fifth electrodes that are arranged at intervals in the second direction,
the first electrodes and the fourth electrodes are disposed on the first surface,
the second electrodes and the fifth electrodes are disposed on the second surface, and
the third electrodes are disposed on the first surface or the second surface.

3. A detecting device comprising:
the detector according to claim 1; and
a calibration voltage supply section configured to supply the calibration voltage to the fourth electrode.

4. The detecting device according to claim 3, wherein the calibration voltage supply section is configured to supply the fourth electrode with a signal having a constant amplitude and a modulated pulse width as the calibration voltage.

5. The detecting device according to claim 3, wherein the calibration voltage supply section is configured to supply the fourth electrode with a signal having a constant pulse width and a modulated amplitude as the calibration voltage.

6. The detecting device according to claim 3, wherein
the fourth electrode includes separated electrodes, and
the calibration voltage supply section is configured to selectively supply the separated electrodes with the calibration voltage.

7. The detecting device according to claim 6, wherein
the detector includes a first substrate that has a first surface and on which at least the first electrode and the fourth electrode are disposed, and a second substrate that has a second surface opposed to and spaced from the first surface and on which at least the second electrode and the fifth electrode are disposed,
the separated electrodes are arranged at intervals in a second direction crossing the first direction and being along the first surface and the second surface, and
the calibration voltage supply section is configured to selectively supply the separated electrodes with a DC voltage as the calibration voltage.

8. The detecting device according to claim 3, further comprising a charged particle supply section configured to supply the detector with the charged particles, wherein
the detector further includes a first substrate that has a first surface and on which at least the first electrode and the fourth electrode are disposed, and a second substrate that has a second surface opposed to and spaced from the first surface and on which at least the second electrode and the fifth electrode are disposed,
the first electrode includes first electrodes that are arranged at intervals in a second direction crossing the first direction and being along the first surface and the second surface,
the second electrode includes second electrodes that are arranged at intervals in the second direction,
the third electrode includes third electrodes that are arranged at intervals in the second direction,
the fourth electrode includes fourth electrodes that are arranged at intervals in the second direction,
the fifth electrode includes fifth electrodes that are arranged at intervals in the second direction,
the charged particle supply section includes charged particle supply sections that are arranged in the second direction, and
the number of the charged particle supply sections is same as the number of each of the first electrodes, the second electrodes, the third electrodes, the fourth electrodes, and the fifth electrodes.

9. The detecting device according to claim 8, wherein
the first electrodes and the fourth electrodes are disposed on the first surface,
the second electrodes and the fifth electrodes are disposed on the second surface, and
the third electrodes are disposed on the first surface or the second surface.

10. The detecting device according to claim 3, wherein
the detector includes a first substrate that has a first surface and on which at least the first electrode and the fourth electrode are disposed, and a second substrate that has a second surface opposed to and spaced from the first surface and on which at least the second electrode and the fifth electrode are disposed, and
the detector includes detectors that are arranged at intervals in a second direction crossing the first direction and being along the first surface and the second surface.

11. A method of detecting charged particles with using a detector that includes a first electrode, a second electrode opposed to and spaced from the first electrode to form a flow space of charged particles between the first electrode and the second electrode in which the charged particles are transferred in a first direction, a third electrode disposed on a downstream side of the first electrode or the second electrode with respect to the first direction and collecting the charged particles, a fourth electrode disposed on an upstream side of the first electrode with respect to the first direction and applied with calibration voltage, and a fifth electrode that is disposed on the upstream side of the second electrode with respect to the first direction and opposed to and spaced from the fourth electrode and to which the charged particles adhere with the fourth electrode being applied with the calibration voltage, the method comprising:
supplying the charged particles to the flow space with no potential difference being created between the first electrode and the second electrode and detecting a first detection voltage by collecting the charged particles with the third electrode;
obtaining a differential voltage by acquiring difference between the first detection voltage and a reference voltage and determining the calibration voltage based on the differential voltage; and
supplying the charged particles to the flow space with creating a potential difference between the first electrode and the second electrode and applying the calibration voltage to the fourth electrode, and detecting a second detection voltage by collecting the charged particles with the third electrode.
